(19) United States
(12) Patent Application Publication
(10) Pub. No.: US 2026/0289168 A1
(43) Pub. Date: Sep. 24, 2026

(54) SYSTEM

(71) Applicant: SoftBank Group Corp., Tokyo (JP)

(72) Inventor: Makoto IWAKIRI, Tokyo (JP)

(73) Assignee: SoftBank Group Corp., Tokyo (JP)

(21) Appl. No.: 19/564,173

(22) Filed: Mar. 12, 2026

(30) Foreign Application Priority Data
Mar. 19, 2025 (JP) 2025-044995

(51) Int. Cl. G06F 40/40; G06F 40/284; G06F 40/35

(52) U.S. Cl. CPC G06F 40/40; G06F 40/284; G06F 40/35

(57) ABSTRACT

A system includes a processor configured to receive user input and apply a generative AI model to perform natural language processing, analyze the input, and generate follow-up questions to collect necessary information. The processor prompts the generative AI model to identify possible diseases based on the collected information and provides the results to a medical professional to support a final diagnosis. The processor further evaluates the patient's emotional state using an emotion analysis engine and provides those results to the medical professional for consideration in the final diagnosis.

### CROSS-REFERENCE TO RELATED APPLICATION

This application is based on and claims priority under 35 USC 119 from Japanese Patent Application No. 2025-044995 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional medical triage and diagnostic support systems that employ natural language processing frequently rely on fixed rules or static models that do not fully exploit the capabilities of generative AI models. As a result, such systems often have limited flexibility in interpreting diverse free-text inputs from users, insufficient ability to dynamically generate appropriate follow-up questions, and constrained performance in extracting clinically relevant information from iterative user interactions. Furthermore, conventional systems generally do not integrate an explicit prompting mechanism to direct generative AI models toward improved analysis accuracy, nor do they provide structured prompts to support higher-quality clinical decision-making by medical professionals. In addition, emotional or psychological aspects of patients, which can be important for comprehensive diagnosis and treatment planning, are often not quantitatively evaluated or systematically reflected in the final diagnosis. Therefore, there is a need for a system that uses generative AI models and an emotion analysis engine in a coordinated manner, employs prompts to improve analysis and diagnostic accuracy, and provides medical professionals with richer, structured information that includes both clinical and emotional state data derived from patient inputs.

### SUMMARY

To solve the above-described problems, the present invention provides a system comprising a processor, wherein the processor is configured to receive input information from a user, perform natural language processing on the received input information by using a generative AI model in order to analyze the input information, generate additional questions based on an analysis result of the natural language processing and present the additional questions to the user, analyze responses from the user again and collect necessary information based on the responses, and input, into the generative AI model, a prompt sentence for instructing the generative AI model to pick up possible diseases on the basis of the collected information. The processor is further configured to provide information, based on a pickup result, for enabling a medical professional to perform a final diagnosis, evaluate an emotional state on the basis of input information from a patient by using an emotion analysis engine, and provide a result of the evaluation of the emotional state to the medical professional so that the result is reflected in the final diagnosis. In one embodiment, the processor is configured to use a prompt for instructing improvement of analysis accuracy when performing the natural language processing based on the input information from the user, thereby enhancing the quality and reliability of the analysis results produced by the generative AI model. In another embodiment, the processor is configured to use a prompt for instructing improvement of diagnosis accuracy when the final diagnosis by the medical professional is performed with reference to an analysis result by the generative AI model, the pickup result, and the result of the evaluation of the emotional state by the emotion analysis engine, thereby supporting more precise and comprehensive clinical decision-making.

The term “system” refers to an arrangement including at least one hardware device and associated software components that cooperate to perform the operations defined in the claims.

The term “processor” refers to one or more hardware processing units, such as a central processing unit (CPU), a graphics processing unit (GPU), or other computation circuitry, that executes instructions to perform the functions described in the claims.

The term “user” refers to a human individual who inputs information into the system and interacts with the system, and may include a patient or a person acting on behalf of a patient.

The term “input information” refers to data provided by the user to the system, including but not limited to free-text descriptions, answers to questions, selections from options, and any other user-entered data relevant to medical assessment.

The term “natural language processing” refers to computational techniques for analyzing and processing human language input, including at least one of tokenization, parsing, semantic analysis, intent recognition, and extraction of medically relevant entities from textual data.

The term “generative AI model” refers to an artificial intelligence model configured to generate text or other content, such as a large language model, that can be prompted to perform natural language processing, generate questions, or infer medical-related information from input data.

The term “additional questions” refers to follow-up inquiries generated by the processor, using the generative AI model, based on analysis of previous input information, in order to obtain further details or clarify the user's condition.

The term “responses” refers to answers or reactions provided by the user to the additional questions, in text form or other input forms, which are subject to further analysis by the system.

The term “necessary information” refers to data elements extracted from the user's input information and responses that are considered relevant for assessing the user's health condition and for identifying possible diseases.

The term “prompt sentence” refers to a text or structured instruction provided by the processor to the generative AI model, which guides or constrains the behavior of the generative AI model to perform a specified task, such as picking up possible diseases.

The term “pick up possible diseases” refers to identifying, from among a plurality of candidate diseases, one or more diseases that are potentially relevant to the user's condition based on the collected information.

The term “pickup result” refers to an output generated by or through use of the generative AI model in response to a prompt sentence, the output including information indicating one or more possible diseases and optionally associated confidence or rationale.

The term “medical professional” refers to a human practitioner qualified to provide medical care, such as a physician, nurse practitioner, or other licensed healthcare provider who performs a final diagnosis based on information provided by the system.

The term “final diagnosis” refers to a clinical determination made by the medical professional regarding the disease or condition affecting the patient, taking into account information provided by the system and other clinical information.

The term “patient” refers to a human individual who is the subject of the medical assessment or diagnosis, and may be the same as the user or represented by the user.

The term “emotion analysis engine” refers to a software and/or hardware component configured to analyze input information from the patient, such as textual expressions, in order to estimate an emotional state, such as anxiety, depression, stress, or other affective conditions.

The term “emotional state” refers to a psychological or affective condition of the patient, such as anxiety level, mood, stress level, or other emotional attributes, inferred from the patient's input information by the emotion analysis engine.

The term “result of the evaluation of the emotional state” refers to output data produced by the emotion analysis engine that quantitatively or qualitatively represents the patient's emotional state, and that can be used as reference information in the final diagnosis.

The term “analysis accuracy” refers to the degree to which the natural language processing and related analysis performed by the generative AI model correctly interprets and extracts medically relevant information from the user's input information.

The term “diagnosis accuracy” refers to the degree to which the final diagnosis made by the medical professional is consistent with the actual medical condition of the patient, potentially improved by reference to analysis results, pickup results, and emotional state evaluation results.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

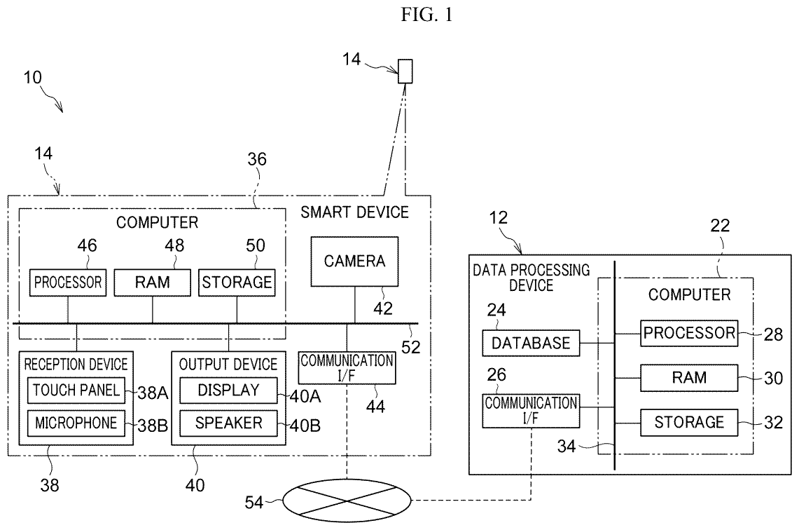

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

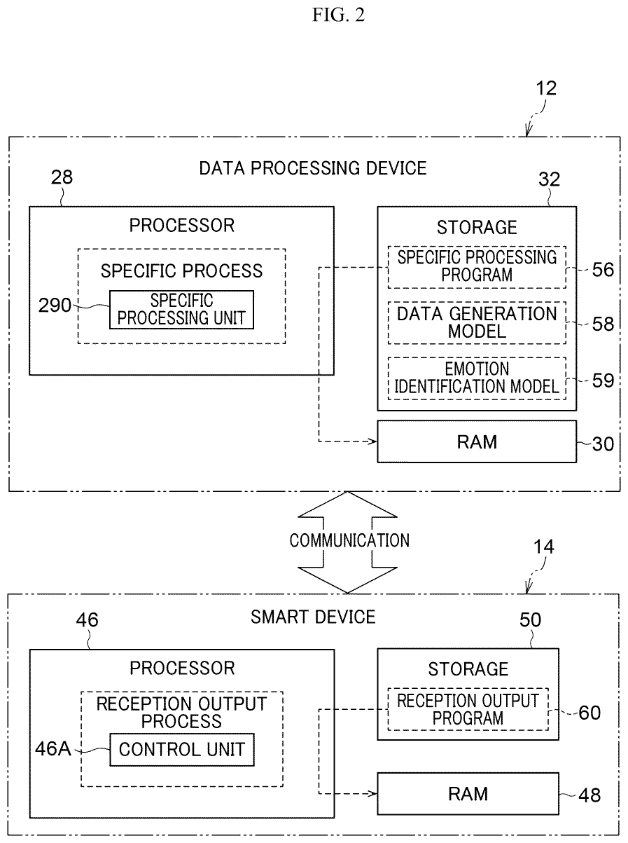

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional primary medical triage systems that rely on fixed rule sets or static question trees suffer from several technical limitations in how information is acquired, represented, and processed by computer systems. In many existing implementations, a server applies predetermined branching logic to user input, which is typically treated as unstructured text without deep contextual analysis. As a result, the server often fails to adaptively refine questions based on the evolving dialogue, leading to redundant queries, missing key clinical details, and inefficient use of computational resources.

Furthermore, typical systems do not maintain and exploit a rich dialogue history as a first-class data structure for downstream computation. User inputs are processed in isolation or in short context windows, which limits the ability of the server to generate coherent follow-up questions and structured symptom representations. This causes fragmentation of information in memory and storage subsystems, and complicates later computation of disease candidates and generation of summaries for medical workers.

In addition, many systems handle symptom extraction and disease candidate identification through separate, loosely integrated modules, each requiring handcrafted rules. This architecture introduces latency and inconsistency between components, and makes it difficult for the server to systematically transform free-form natural language input into structured data suitable for automated ranking of disease candidates and generation of machine-readable and human-readable medical information.

Existing solutions also rarely integrate emotion analysis as a computational signal into the same processing pipeline. Emotion information, if present, is often logged as auxiliary metadata and is not tightly coupled to the structured symptom data and disease candidate data. Consequently, the server cannot effectively provide a unified representation of clinical and emotional states to a medical worker-side information processing apparatus.

Moreover, generative AI models are typically invoked in a naïve manner, such as through single-turn prompts that do not encode explicit instructions for improving analysis accuracy, coverage of information extraction, or consistency and explainability of final diagnosis support. This underutilizes the capabilities of the generative AI models, resulting in suboptimal outputs and increased need for manual intervention. From a computer technology standpoint, this means that the server does not leverage prompt design, dialogue history management, and model orchestration as systematic mechanisms to improve the quality and reliability of the overall processing pipeline.

Accordingly, there is a need for a technical solution in which a server controls a generative AI model via carefully constructed prompt sentences, manages dialogue history as a core data structure, repeatedly performs adaptive analysis and question generation until sufficient information is collected, structurally transforms the accumulated dialogue into structured symptom information, computes ranked disease candidate lists using that structured information, and integrates emotion analysis results into a unified set of medical information for delivery to medical worker-side information processing apparatuses. Such a solution should improve the technical operation of the computer system itself, including data acquisition, data structuring, and coordinated use of generative AI and emotion analysis components, thereby enhancing processing efficiency, accuracy, consistency, and explainability in a primary medical triage environment.

The specific processing by the specific processing unit 290 of the data processing device 12 in Example 1 is realized by the following means.

The present invention provides a server comprising a processor, a storage device, and interfaces to a plurality of information processing apparatuses, the processor being configured to (i) receive, via a user-side information processing apparatus, symptom information and selection information expressed in natural language from a user and store the symptom information and the selection information as dialogue history on a per-user basis in the storage device, (ii) generate prompt sentences including the dialogue history as input information to a generative AI model that performs natural language processing and input the prompt sentences to the generative AI model so as to instruct the generative AI model to execute analysis processing on the input information, (iii) generate, based on an analysis result output from the generative AI model, one or more additional question sentences for obtaining additional information required for diagnosis from the user and transmit the one or more additional question sentences to the user-side information processing apparatus so that the one or more additional question sentences are presented to the user, (iv) acquire, from the user-side information processing apparatus, response content from the user to the one or more additional question sentences, sequentially add the response content to the dialogue history to update the dialogue history, and repeatedly execute the analysis processing and generation of the one or more additional question sentences until necessary information is collected by generating and transmitting, for the updated dialogue history, further prompt sentences to be input to the generative AI model, (v) generate prompt sentences including structuring instructions for inputting dialogue history collected by the repeated execution to the generative AI model, input the prompt sentences to the generative AI model so as to instruct the generative AI model to execute structuring processing on symptom information contained in the dialogue history, and acquire structured symptom information output from the generative AI model, (vi) compare the structured symptom information with disease information stored in the storage device, calculate, for a plurality of disease candidates, a relevance value for each of the plurality of disease candidates with respect to the structured symptom information, and extract a disease candidate list including the plurality of disease candidates and the relevance values, (vii) generate medical information including the structured symptom information and the disease candidate list and provide the medical information to a medical-worker-side information processing apparatus, and (viii) evaluate an emotional state based on input information from a patient by using an emotion analysis engine and provide, to the medical-worker-side information processing apparatus, a result of evaluation of the emotional state by the emotion analysis engine in association with the medical information. This enables the computer system to dynamically manage dialogue history as structured data, to orchestrate generative AI model calls through tailored prompt sentences for iterative analysis and question generation, to automatically convert unstructured natural language interactions into structured symptom and disease candidate representations, and to integrate emotion analysis results into a unified output, thereby improving the technical performance of the server in terms of accuracy, consistency, and efficiency of medical triage information processing.

The term “processor” refers to a hardware or virtual processing unit, such as a central processing unit or a programmable logic device, configured to execute instructions to perform data acquisition, data analysis, control of external components, and generation and transmission of information within the system.

The term “storage device” refers to a hardware component or logical storage resource, such as a memory device or a persistent storage medium, configured to store dialogue history, structured symptom information, disease information, medical information, and other data used or generated by the processor.

The term “information processing apparatus” refers to an electronic device equipped with computation, communication, and display capabilities, such as a computing terminal or a communication terminal, that is configured to exchange data with the server and present information to a user or a medical worker.

The term “user-side information processing apparatus” refers to an information processing apparatus operated by or accessible to a patient or non-professional user, and configured to transmit symptom information and selection information to the server and to present questions and responses generated by the server.

The term “medical-worker-side information processing apparatus” refers to an information processing apparatus operated by or accessible to a medical worker, and configured to receive and display medical information, disease candidate lists, emotion analysis results, and other diagnostic support information from the server.

The term “symptom information” refers to information describing a physical or mental condition of a patient, expressed in natural language or in selected items, including but not limited to complaints, durations, frequencies, severities, and associated phenomena.

The term “selection information” refers to information representing one or more selected items from a set of predefined options, such as symptom categories, check boxes, or multiple-choice entries, which is provided by a user through an input interface.

The term “dialogue history” refers to a collection of one or more interaction records, including user inputs, system outputs, and analysis results, accumulated over time for a given session or user, and stored as a structured or semi-structured data set for subsequent processing.

The term “generative AI model” refers to a trained machine learning model that generates or transforms natural language content by predicting sequences of tokens based on input data, and that is configured to perform tasks such as analysis of text, generation of question sentences, and structuring of symptom information.

The term “prompt sentence” refers to a text or data structure provided as input to a generative AI model, including instructions, context, and example data, which conditions or constrains the operation of the generative AI model to perform a desired task such as analysis, question generation, or summarization.

The term “analysis process” refers to a sequence of operations performed by the generative AI model and the processor, including parsing, interpretation, feature extraction, and inference on input information, to derive analysis results such as key symptoms, missing information, or candidate questions.

The term “additional question sentence” refers to a natural language expression generated to elicit further information from a user, based on analysis results of prior inputs, and intended to improve completeness and precision of collected symptom information.

The term “structuring process” refers to a process in which unstructured or semi-structured text data, such as dialogue history, is transformed into structured data with predefined fields, such as symptom types, durations, frequencies, severities, and associated conditions.

The term “structured symptom information” refers to symptom-related data obtained by the structuring process, represented in a predefined format or schema, suitable for machine processing such as comparison, scoring, and ranking.

The term “disease information” refers to stored data representing characteristics of diseases, such as associated symptoms, typical durations, severities, and other attributes, which are used by the processor to compare with structured symptom information and derive disease candidates.

The term “disease candidate” refers to a disease or condition that is identified by the processor as potentially corresponding to the structured symptom information, based on comparison with disease information.

The term “relevance value” refers to a numerical or ordinal indicator calculated by the processor to represent a degree of correspondence or likelihood between a disease candidate and structured symptom information.

The term “disease candidate list” refers to a data structure that includes one or more disease candidates and associated relevance values, generated by the processor as a ranking or grouping of possible diseases.

The term “medical information” refers to information generated for use by a medical worker, including structured symptom information, disease candidate lists, summaries of dialogue history, and related diagnostic support data.

The term “emotion analysis engine” refers to a software module or a combination of hardware and software configured to analyze input information, such as natural language text, and output an estimation of an emotional state, such as anxiety, distress, or calmness, of a patient.

The term “emotional state” refers to a condition or level of emotion inferred from patient input, represented by one or more categories, scores, or descriptors, and used as an additional signal in diagnostic support.

The term “analysis result” refers to an output produced by the generative AI model or by the processor as a consequence of the analysis process, including extracted features, inferred attributes, and suggested follow-up questions.

The term “summary information” refers to text or structured data that concisely represents the content of dialogue history, structured symptom information, and disease candidate information, generated for use as a reference in final diagnosis.

The term “explanation information” refers to information that describes reasoning, relationships, or justifications connecting structured symptom information, disease candidates, and other analysis results, to improve interpretability and explainability for a medical worker.

In one embodiment, a server implements the claimed system as a network-based primary triage platform that cooperates with one or more terminals operated by users and medical workers. The server comprises at least one processor, a storage device, a communication interface, and executable software modules. The processor is, for example, a multi-core central processing unit or a combination of a central processing unit and a graphics processing unit, installed in a data center. The storage device is, for example, a non-transitory storage medium such as a solid-state drive and a volatile memory such as a dynamic random access memory. The server executes a web application framework, such as a general-purpose server framework, and exposes application programming interfaces over a communication network to the terminals.

The terminal is, for example, a smartphone, a tablet, or a personal computer that includes a display, an input device, a wireless or wired communication interface, and a local processor.

The terminal executes a web browser or a native application that renders a chat-style user interface. The user operates the terminal to input symptom descriptions in natural language and to select options presented on the display. The terminal converts input operations into structured request data and transmits the data to the server over a secure communication protocol.

The server stores, in the storage device, disease information, dialogue history information, model configuration information, and emotion analysis configuration information. The disease information includes, as a table-like data structure, for each disease record, attribute fields such as disease identifier, associated symptom identifiers, typical duration ranges, typical severity ranges, and probability weights. The dialogue history information includes, for each session or user, an ordered list of message records. Each message record includes fields such as role (user, assistant, system), timestamp, and content text. The model configuration information includes identifiers and hyperparameters for a generative AI model, and the emotion analysis configuration information includes model parameters and feature mappings for an emotion analysis engine.

The server uses a generative AI model implemented as a large-scale neural network for natural language processing. In one embodiment, the generative AI model has a transformer architecture including a plurality of self-attention layers, feedforward layers, layer normalization components, and embedding layers. The model receives tokenized sequences of text and outputs probability distributions over token vocabularies. The model has been trained in advance on large corpora of natural language texts using a supervised or semi-supervised learning procedure. During training, the server or an external training environment applies an objective function such as cross-entropy loss between predicted token distributions and ground-truth tokens, and updates model weights using an optimization algorithm such as stochastic gradient descent or an adaptive gradient method. The training may include data augmentation methods such as random masking, random truncation, or synonym substitution to improve robustness. After training, the model parameters are fixed or fine-tuned on medical-domain data so that the model can handle symptom descriptions and medical terminology.

The server implements, as a software module, a prompt generation module that constructs prompt sentences for the generative AI model. The prompt generation module reads the dialogue history from the storage device and formats the dialogue as a sequence of role-tagged segments. The server also inserts explicit instructions into the prompt sentences to guide the behavior of the generative AI model. For example, the server generates a prompt sentence such as:

“System: You are a medical triage assistant. Task: Based on the symptoms entered by the user, generate additional questions to collect more detailed medical information. User input: ‘Recently, I have had continuous headaches.’ Output: Provide 2 to 4 concise follow-up questions in natural language.”

In another example, the server generates a prompt sentence such as:

“Based on the symptoms entered by the user, generate additional questions to collect medical information efficiently. User input: ‘Recently, I have had continuous headaches.’”

In another example, when the server requires a direct response rather than questions, the server generates a prompt sentence such as:

“Generate an appropriate chatbot response for primary medical triage to the following user input: ‘I have a stomachache.’”

In yet another example, when the server requires a structured representation, the server generates a prompt sentence such as:

“You are a medical note generator. Task: Convert the following conversation into structured medical data (symptoms, duration, frequency, severity, associated symptoms). Conversation: [dialogue text]. Output: JSON-like fields: symptoms, duration, frequency, severity, associated_symptoms, notes.”

The server encodes these prompt sentences into token sequences using a tokenizer associated with the generative AI model. The server then feeds the token sequences into the model and obtains output token sequences corresponding to generated questions, structured data descriptions, or summary texts. The server decodes the output token sequences into text and, when necessary, parses the text into internal representations such as lists of questions or field-value pairs.

The server controls the generative AI model not merely as a black-box text generator, but through specific orchestration logic that manages dialogue history and prompt content. The server maintains the dialogue history as a structured in-memory object with indexes, so that the server can efficiently retrieve relevant segments for each new model invocation. The server selects only the most relevant recent messages and a fixed number of earlier summary messages in order to control the context length and reduce unnecessary model computation.

This selection process reduces communication load and computation cost inside the model by limiting input length without sacrificing essential context, thus improving calculation efficiency.

The server also uses specialized prompts that contain condition information for improving analysis accuracy and comprehensiveness. For example, when the server performs analysis on user input to detect missing clinical information, the server inserts in the prompt a directive such as “Identify all missing but medically relevant attributes (onset, duration, frequency, severity, location, associated symptoms) and generate questions to fill these gaps.”

This explicit enumeration of attributes constitutes a non-conventional rule set for question generation that differs from simple human-style triage scripts, because the server systematically ties prompt content to specific data schema fields used for downstream structured symptom information.

The server implements an algorithm that transforms unstructured dialogue text into structured symptom information. After obtaining text output from the generative AI model that follows a predefined structure (for example, key-value pairs for “symptoms,” “duration,” “frequency,” and so on), the server parses the text using pattern matching or a parser module that expects labeled segments. The server maps natural language expressions to normalized internal codes. For example, the server maps “every day” to a frequency code such as “DAILY,” and maps numerical severity descriptions such as “7 out of 10” to integer scores within a defined severity range. This mapping uses a translation table stored in the storage device and rules implemented in the processor. By converting free-form text into schema-conforming structured symptom information, the server reduces ambiguity and improves suitability for later computation of disease candidates.

The server performs disease candidate computation by comparing structured symptom information to disease information. The server loads disease records from the storage device into an in-memory data structure such as an array or hash map keyed by disease identifiers.

For each disease record, the server evaluates a scoring function that takes as inputs the structured symptom information and disease attributes. The scoring function may, for example, compute a weighted sum of symptom matches, where each potential symptom has an associated weight and the match term is a similarity score between the user's symptom attributes and the disease's typical attributes. The server may also penalize mismatches in duration or severity. The result of this computation is a numerical relevance value for each disease. The server sorts disease identifiers by relevance value to produce a disease candidate list. This numerical computation and sorting process is performed entirely inside the server's processor and uses deterministic algorithms, thereby providing repeatability and stability superior to ad hoc manual evaluation.

The server further integrates an emotion analysis engine as a separate module. The emotion analysis engine uses a neural network, such as a recurrent neural network or a transformer-based classifier, that has been trained on labeled emotion data. The engine receives as input text segments from the dialogue history and transforms the text into feature vectors using an embedding layer. The neural network computes, for each input, scores for emotion categories such as “anxiety,” “fear,” “sadness,” and “calm.” The training procedure uses a loss function such as categorical cross-entropy between predicted emotion category distributions and ground-truth labels and updates weights through gradient-based optimization. The server sets one or more thresholds on these scores to classify the user's emotional state or to generate a multi-dimensional emotion vector. The server stores the emotion state in association with the dialogue history and attaches it to the medical information that is delivered to the medical-worker-side terminal.

The server uses the emotion analysis result not only as metadata but also as a control parameter for subsequent processing. For example, when the emotion analysis engine detects a high probability of anxiety, the server adjusts the prompt sentences to the generative AI model by including additional instructions such as “Use reassuring language and avoid technical jargon while still collecting necessary medical details.” This fine-grained prompt customization produces outputs that are both medically informative and emotionally appropriate. This is not a mere automation of human behavior; rather, it leverages the emotion vector to programmatically control the behavior of a large-scale generative AI model in ways that humans cannot execute consistently or at high speed across many parallel sessions.

The terminal displays, on a chat-style screen, the questions and messages generated by the server. The terminal renders text using a user interface framework and performs local operations such as scroll management and input focus control. The terminal sends user responses back to the server, and the server immediately processes them using the generative AI model and the described algorithms. Because the server manages dialogue history in a compact, indexed structure and limits the text passed into the generative AI model by selectively including only contextually relevant messages, the system reduces the amount of data transmitted over the network and the number of tokens processed by the model. This contributes to lower latency and reduced computational burden, which are concrete technical improvements in system performance.

The server generates, after a sufficient amount of data has been collected, medical information for a medical worker. This medical information includes a text summary and structured fields. The server may use another prompt sentence targeted for summarization: “You are preparing a summary for a doctor. Task: Summarize the following structured data and conversation into a concise clinical note and list the possible diseases. Structured data: [structured symptom information]. Conversation: [dialogue history].”

The server sends this prompt sentence to the generative AI model and obtains a summary text that concisely describes the symptoms, onset, duration, frequency, severity, and other relevant aspects. The server then packages the summary together with the disease candidate list and emotion state and transmits these data to the medical-worker-side terminal. The medical worker reads the summary and candidate list and uses them as reference when making a final diagnosis.

This architecture yields several technical effects. First, the server achieves improved analysis accuracy and completeness because the prompt sentences explicitly reference structured schemas and missing attribute categories, guiding the generative AI model to focus on completing data structures rather than loosely responding to user input. Second, the server improves computation efficiency by actively compressing and managing the dialogue history and by orchestrating model invocation frequency, thereby reducing redundant processing.

Third, the server improves data management by converting all relevant interaction data into structured symptom information and disease candidate lists, enabling consistent storage, indexing, and retrieval. Fourth, the server improves the consistency and explainability of the generated outputs because the same structured schemas and scoring algorithms are used for both generative prompts and deterministic candidate ranking, and the server can generate explanation information that explicitly connects symptom attributes to candidate scores.

The described system is not limited to a single generative AI model. In one variant, the server uses a first generative AI model specialized in question generation and a second generative AI model specialized in summarization. The server routes prompt sentences to the appropriate model and adjusts hyperparameters such as temperature and maximum output length per task. In another variant, the server uses a smaller local model for preliminary filtering or extraction and a larger remote model for final question generation or summarization, thus optimizing computational cost. In yet another variant, the server replaces the neural emotion analysis engine with a rule-based classifier for environments where model deployment is constrained, while maintaining the same interface to the rest of the system.

In still another embodiment, the server incorporates a feedback loop where the medical worker can adjust weights for disease attributes or can annotate incorrect generative outputs.

The server stores these annotations and may periodically trigger a re-training or fine-tuning process for the generative AI model or the emotion analysis engine. During such training, the server uses error functions that penalize mismatch between desired structured outputs and generated outputs, and updates parameters using gradient descent. This continuous learning pipeline constitutes a technical improvement because it reduces systematic errors over time and adapts the system to specific clinical environments while maintaining the automated orchestration of prompts and structured data handling described above.

By tying the design of prompt sentences, the management of dialogue history, the structuring of symptom information, the computation of disease candidates, and the integration of emotion analysis into a coherent, technically specified pipeline, the server improves the operation of the underlying computer system itself. The combination of specialized data structures, deterministic scoring algorithms, and controlled use of transformer-based generative AI models yields higher throughput, lower error rates, and more reliable interaction behavior than conventional fixed decision-tree triage or naïve single-turn AI chatbots.

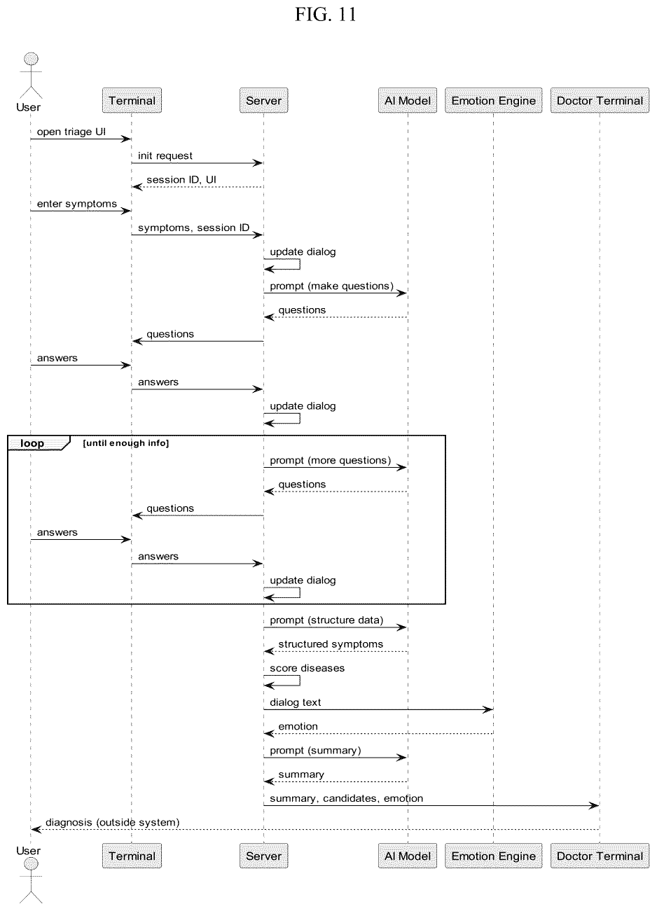

The following describes the processing flow using FIG. 11.

### Step 1:

The user operates the terminal to access a triage application and initiates a new session.

The terminal sends an initialization request to the server including a terminal identifier and, if available, a user identifier.

Input: user operation on the terminal UI (screen tap, button click) and terminal identifier.

Output: an HTTPS request from the terminal to the server requesting session initialization.

### Step 2:

The server receives the initialization request and generates a session identifier.

The server allocates a new dialogue history data structure in memory and in the storage device, associating it with the session identifier.

Input: initialization request containing terminal identifier and optional user identifier.

Data processing: the server executes a random or sequential ID generation algorithm, creates an empty list or array for dialogue messages, and writes an initial record to the storage device.

Output: a response including the session identifier and initial UI configuration data sent to the terminal.

### Step 3:

The terminal receives the session identifier and configures a chat-style UI for the user.

The terminal displays an input field for free-text entry and optional selectable symptom categories or options.

Input: server response containing session identifier and UI parameters.

Data processing: the terminal stores the session identifier locally in memory, binds it to the current chat view, and initializes UI components.

Output: a rendered chat screen ready to receive symptom input from the user.

### Step 4:

The user inputs symptom information into the terminal by typing natural language text (for example, “Recently, I have had continuous headaches.”) and optionally selecting symptom options.

The terminal collects the typed text and selected options when the user confirms the input.

Input: keystrokes and selection events on the terminal.

Data processing: the terminal aggregates the textual content and selected option identifiers into an internal data object.

Output: a structured request payload containing the session identifier, symptom text, and selection information prepared for transmission to the server.

### Step 5:

The terminal transmits the structured request payload to the server via HTTPS.

The terminal includes the session identifier, user-input text, and selection information in the request body.

Input: structured request payload in memory.

Data processing: the terminal serializes the internal data object (for example, to JSON) and sends it over the network stack.

Output: an HTTP request received by the server containing the user's initial symptom information.

### Step 6:

The server receives the request and parses the incoming data.

The server validates the session identifier, ensures that required fields such as symptom text are present, and checks basic format constraints.

Input: HTTP request containing session identifier, user-input text, and selection information.

Data processing: the server deserializes the request body, verifies types and presence of fields, and generates error responses if validation fails.

Output: a validated input object stored in server memory for further processing.

### Step 7:

The server appends the user's input to the dialogue history for the session.

The server creates a message record with fields such as role=“user,” timestamp, and content=user-input text, and stores it in the storage device.

Input: validated input object and current dialogue history for the session.

Data processing: the server inserts a new message into the dialogue history list, updates indices, and commits the updated dialogue history to storage.

Output: an updated dialogue history that includes the user's latest message.

### Step 8:

The server generates a prompt sentence for the generative AI model to analyze the user's input and produce additional questions.

The server retrieves relevant dialogue history entries, concatenates them with system instructions, and formats them into a prompt sentence.

Input: updated dialogue history and configuration data for question generation prompts.

Data processing: the server selects a subset of messages (for example, the latest user message and previous assistant messages), assembles them in a predefined template, and produces a text prompt such as:

“System: You are a medical triage assistant. Task: Based on the symptoms entered by the user, generate additional questions to collect more detailed medical information. User input: ‘Recently, I have had continuous headaches.’ Output: Provide 2 to 4 concise follow-up questions in natural language.”

Output: a prompt sentence text ready to be tokenized and sent to the generative AI model.

### Step 9:

The server encodes the prompt sentence and calls the generative AI model.

The server uses a tokenizer associated with the generative AI model to convert the prompt sentence into token IDs and sends these token IDs, along with model parameters such as maximum token count and temperature, to the model inference engine.

Input: prompt sentence text and model configuration parameters.

Data processing: the server performs tokenization, constructs an inference request containing input token sequences and parameter values, and transmits this request to a model-serving component running on a computing device, such as a GPU-equipped server.

Output: an inference request executed by the generative AI model and, subsequently, an inference response containing output token sequences.

### Step 10:

The generative AI model, running on the server-side infrastructure, processes the input token sequence.

The model applies transformer layers including self-attention, feedforward networks, and normalization to compute probability distributions over tokens at each position and then samples or selects output tokens to form question sentences.

Input: tokenized prompt and model parameters.

Data processing: the model performs matrix multiplications, attention score computations, non-linear activations, and softmax operations across multiple layers to generate output tokens that satisfy the prompt instructions.

Output: a sequence of output token IDs that represent one or more additional question sentences.

### Step 11:

The server decodes the output token IDs into text and extracts individual questions.

The server converts token IDs back to text, segments the text by punctuation or line breaks, and filters out empty or malformed segments.

Input: output token IDs from the generative AI model.

Data processing: the server applies the tokenizer's decode function, performs string splitting and trimming, and validates that each segment ends with a question mark or otherwise conforms to a question pattern.

Output: a list of question texts representing additional questions to be presented to the user.

### Step 12:

The server adds the generated questions to the dialogue history and prepares a response for the terminal.

The server creates a new assistant message containing the concatenated questions and appends it to the dialogue history for the session in the storage device.

Input: list of question texts and current dialogue history.

Data processing: the server merges the questions into a single message or a structured list, updates the dialogue history data structure, and constructs a response object that contains the questions and updated conversation context markers.

Output: an HTTP response payload containing the additional question sentences for the terminal.

### Step 13:

The terminal receives the response and displays the additional questions to the user.

The terminal updates the chat interface by adding new message bubbles for the questions, scrolling the view as needed to ensure visibility.

Input: HTTP response payload containing question texts.

Data processing: the terminal parses the payload, constructs UI elements for each question, and updates the on-screen message list.

Output: a visual display of the generated questions on the terminal's screen.

### Step 14:

The user reads the additional questions and inputs new answers on the terminal.

The user types text responses (for example, “The headache occurs every day, and the pain is 7 out of 10.”) and optionally selects further options if provided.

Input: displayed question texts and user interaction with the terminal UI.

Data processing: the terminal records user keystrokes and selection events and aggregates them into an answer message associated with the current session.

Output: a structured answer payload containing the session identifier and user response text.

### Step 15:

The terminal transmits the user's new answers to the server.

The terminal sends an HTTPS request including the session identifier, the answer text, and any updated selection information.

Input: structured answer payload generated on the terminal.

Data processing: the terminal serializes the payload and sends it through the communication interface to the server.

Output: an HTTP request received by the server containing follow-up answers.

### Step 16:

The server receives the follow-up answers and updates the dialogue history accordingly.

The server parses the request, validates the session identifier, and creates a new user message record that is appended to the dialogue history stored in the storage device.

Input: HTTP request containing user answer text and session identifier.

Data processing: the server deserializes the request, performs validation, updates the in-memory dialogue history object, and writes changes to the storage device.

Output: an updated dialogue history that now includes both previous questions and the user's follow-up answers.

### Step 17:

The server determines whether sufficient information has been collected or whether additional questions are required.

The server may either apply rules (such as a minimum set of symptom attributes) or use a dedicated analysis prompt to the generative AI model to check completeness.

Input: updated dialogue history and configuration rules for completeness.

Data processing: the server evaluates whether all required fields (for example, onset, duration, frequency, severity, location, associated symptoms) have been populated; if not, the server generates another prompt sentence instructing the generative AI model to propose further follow-up questions.

Output: a decision flag indicating either “continue question generation” (leading back to Steps 8-12) or “proceed to structuring and scoring.”

### Step 18:

When sufficient data is collected, the server generates a prompt sentence to transform the dialogue history into structured symptom information.

The server selects relevant dialogue messages and composes a prompt sentence that instructs the generative AI model to output structured attributes.

Input: complete dialogue history and a structuring template.

Data processing: the server formats the prompt as text, such as:

“You are a medical note generator. Task: Convert the following conversation into structured medical data (symptoms, duration, frequency, severity, associated symptoms). Conversation: [dialogue text]. Output: fields: symptoms, duration, frequency, severity, associated_symptoms, notes.”

Output: a structuring-focused prompt sentence ready to be sent to the generative AI model.

### Step 19:

The server sends the structuring prompt to the generative AI model and obtains structured symptom information.

The server tokenizes the prompt, calls the generative AI model, and decodes the output into a format that delineates individual fields.

Input: structuring prompt sentence and model parameters.

Data processing: the server processes the output text to identify labels and values for symptom attributes, then normalizes the values using predefined mapping rules.

Output: a structured symptom information object containing normalized fields such as symptoms list, duration, frequency, severity score, and associated symptoms.

### Step 20:

The server computes disease candidate scores based on the structured symptom information.

The server loads disease information from the storage device and applies a scoring algorithm for each disease record.

Input: structured symptom information and disease information table.

Data processing: the server evaluates a scoring function that compares user symptoms with disease attributes, calculates weighted similarity values, aggregates matches into a relevance value, and sorts diseases by relevance.

Output: a disease candidate list that contains disease identifiers and associated relevance values.

### Step 21:

The server performs emotion analysis on the dialogue history.

The server extracts user message texts from the dialogue history and feeds them into the emotion analysis engine.

Input: dialogue history containing user messages.

Data processing: the emotion analysis engine converts text into feature vectors, applies a trained neural network classifier, computes probabilities for emotion categories, and outputs an emotional state designation or vector.

Output: an emotion analysis result representing the user's emotional state.

### Step 22:

The server compiles medical information for the medical-worker-side terminal.

The server combines the structured symptom information, the disease candidate list, and the emotion analysis result into a medical information package, and may generate a natural language summary using another prompt sentence sent to the generative AI model.

Input: structured symptom information, disease candidate list, emotion analysis result, and optionally a summarization prompt.

Data processing: the server assembles these components into a unified data object, generates a summary text if required, and formats the package for transmission.

Output: a medical information response that includes structured data and summary text.

### Step 23:

The server transmits the medical information to the medical-worker-side terminal.

The server sends the data over a secure channel, including the summary, candidate list, and emotion state.

Input: medical information package in server memory.

Data processing: the server serializes the data and uses the communication interface to deliver it to the designated medical-worker-side terminal.

Output: an HTTP or similar protocol response received by the medical-worker-side terminal.

### Step 24:

The terminal used by the medical worker receives and displays the medical information.

The terminal renders the summary, structured fields, and candidate list in a dashboard or detail view.

Input: medical information response from the server.

Data processing: the terminal parses the data, lays out UI components for each field, and optionally allows the medical worker to scroll, filter, or annotate the information.

Output: a visual representation of the triage result and supporting data on the medical worker's screen.

### Step 25:

The server optionally accepts feedback or annotations from the medical worker for system improvement.

The server receives corrections or comments on structured symptom information or disease candidate ranking, and stores them for later use in model fine-tuning or rule adjustment.

Input: feedback data submitted from the medical-worker-side terminal.

Data processing: the server associates the feedback with the corresponding session, updates training or configuration datasets, and may schedule offline processing for model or rule updates.

Output: updated configuration or training data that improve future performance and accuracy of the system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialog systems that rely on natural language processing often treat medical triage tasks and commercial inquiry handling as separate application domains implemented by distinct software stacks. In such systems, a user terminal typically transmits raw or minimally processed text to a server, and the server executes a sequence of rigid, rule-based procedures to generate responses. This architecture introduces several technical problems from a computer-technology standpoint.

First, because intent recognition, entity extraction, context selection, and response generation are often implemented as disjoint components without unified control over prompting to a generative AI model, the system may require multiple passes of analysis and heuristic post-processing. This results in increased computational overhead on the server, suboptimal use of model computation resources, and latency that is noticeable to the user, particularly under high load or when handling multi-turn conversations.

Second, existing systems typically do not adapt the prompt content and structure dynamically based on mode (for example, healthcare versus commercial), extracted entities, historical dialog context, and safety constraints. As a result, the generative AI model may generate unnecessarily verbose, inconsistent, or unsafe responses, which then require additional filtering or manual review. This degrades overall throughput of the server, increases memory and storage consumption for logging and moderation, and limits scalability in a multi-user environment.

Third, many known architectures treat emotional state analysis, epidemic sign detection, and domain-specific support for human experts as post-hoc analytics rather than as integrated, first-class inputs to the response generation pipeline. Data related to symptoms, emotional cues, and temporal or regional distributions of inputs is often stored and processed in batch form, separated from the live conversational flow. This separation causes redundant data movement between subsystems, repeated parsing and re-analysis of the same input information, and inefficient utilization of storage and processing resources, thereby impairing the responsiveness and robustness of the overall system.

Fourth, when handling multi-turn dialog, conventional systems frequently maintain only shallow session state or rely on the client side to track context, leading to fragmented histories and duplicated computation on the server for each turn. The lack of a server-side mechanism to aggregate and structure conversation history into prompt sentences for the generative AI model forces the system to re-interpret each user utterance from scratch, wasting processing cycles and increasing the probability of inconsistent response behavior across turns.

Accordingly, there is a need for an improved computer-implemented system that: (i) unifies intent analysis, mode selection, context retrieval, and prompt sentence construction for a generative AI model; (ii) integrates safety checking, emotional state evaluation, and epidemic sign detection directly into the online response generation flow; and (iii) efficiently manages and reuses dialog history to support multi-turn conversations across multiple domains. Such a system should reduce processing redundancy, improve utilization of generative model computation, and provide a technically enhanced, scalable architecture for real-time healthcare and commercial support services.

The specific processing by the specific processing unit 290 of the data processing device 12 in Application Example 1 is realized by the following means.

The present invention provides a server comprising a processor configured to obtain, from a communication interface, text data generated from user input by a user terminal, to analyze the text data by using natural language processing resources to determine at least one of an intention and elements in the text data, to determine, based on an analysis result, a processing mode relating to at least one of symptom information in a healthcare field and product information or service information in a commercial field, to retrieve, from a storage device, rule information or domain information corresponding to the processing mode, to generate a prompt sentence for a generative AI model based on the analysis result and the retrieved information, to input the prompt sentence into the generative AI model and obtain a response sentence, to apply post-processing to the response sentence including at least one of safety checking and content formatting, to structure the post-processed response sentence as answer information including indicator information for a possible epidemic disease and support information for a final diagnosis in the healthcare field or including usage information or inquiry response information in the commercial field, to accumulate history information relating to user inputs and response sentences for use in generating additional questions for multi-turn dialog, to aggregate symptom-related information from multiple users and analyze temporal and regional patterns to detect a sign of occurrence of an epidemic disease, and to evaluate an emotional state based on the text data by using an emotion analysis function and reflect an evaluation result of the emotional state in the answer information and in information provided to a human expert. This enables unified, server-side orchestration of intent analysis, mode selection, prompt sentence construction for the generative AI model, and integrated safety and analytics processing, thereby reducing redundant computation, improving responsiveness and scalability of dialog handling, and enhancing the technical performance of computer systems that provide real-time healthcare triage support and commercial inquiry support.

The term “user terminal” refers to an information processing apparatus operated by a user, including, for example, a portable electronic device or a stationary electronic device having at least an input interface, a display interface, and a communication interface for exchanging data with a server.

The term “input information” refers to data representing a user's utterance or operation, including at least textual data and data obtained by converting audio data into text data, and expressing a question, a symptom, a request, or other content in natural language.

The term “audio data” refers to time-series data representing sound captured by an acoustic sensor, such as a microphone, and suitable for digital signal processing and conversion into text data by a speech recognition function.

The term “character data” refers to data composed of one or more characters encoded in a character code system and representing information input by the user through a text-based interface such as a keyboard or a touch panel.

The term “speech recognition function” refers to a software-implemented or hardware-implemented function that converts audio data representing spoken language into corresponding text data by applying pattern recognition, acoustic modeling, and language modeling.

The term “text data” refers to a string of characters representing linguistic content that has been generated by the user directly or obtained by converting audio data through the speech recognition function.

The term “mode information” refers to data indicating a processing category to be applied to input information, including at least a healthcare mode and a commercial mode, and used by the server to select domain-specific processing logic and data.

The term “identification information” refers to data that uniquely or pseudo-uniquely identifies at least one of a user, a device, a session, or a request, and that is associated with input information or communication data for tracking and processing purposes.

The term “communication data” refers to structured data generated by associating text data with metadata including mode information and identification information, and formatted for transmission between the user terminal and the server via a communication network.

The term “server” refers to an information processing system including at least one processor, a memory, a storage device, and a communication interface, and configured to receive communication data from user terminals, execute analysis and generation processes, and return response data.

The term “communication path” refers to a logical or physical connection established over a communication network between the user terminal and the server for transmitting and receiving communication data.

The term “natural language processing resources” refers to software modules, algorithms, and data structures used to analyze text data in natural language, including at least tokenization, part-of-speech tagging, intent classification, entity recognition, and semantic analysis.

The term “intention” refers to an inferred purpose or objective of the user's input, such as a request for medical triage, a question about product usage, or a request for service-related information.

The term “elements” refers to constituent information units extracted from the input information, including, for example, symptoms, product names, quantities, durations, locations, and other semantic entities.

The term “processing mode” refers to a specific category of processing determined by the server based on an analysis result of the input information, including at least a processing mode relating to symptom information in a healthcare field and a processing mode relating to product information or service information in a commercial field.

The term “symptom information” refers to information representing a user's or patient's physical or mental condition expressed as symptoms, such as fever, cough, duration of illness, or degree of pain.

The term “healthcare field” refers to a technical domain in which information is processed for purposes including medical triage, preliminary assessment, and support for diagnosis and treatment conducted by medical professionals.

The term “product information” refers to structured or unstructured data relating to a commercial product, including at least a product name, a specification, a usage method, safety precautions, and frequently asked questions.

The term “service information” refers to structured or unstructured data relating to a commercial service, including at least service content, usage conditions, pricing, and procedures for application, cancellation, or support.

The term “commercial field” refers to a technical domain in which information is processed for purposes including customer support, inquiry handling, and provision of information related to products or services.

The term “information storage device” refers to a non-transitory computer-readable storage medium, such as a semiconductor memory, a magnetic storage medium, or an optical storage medium, configured to store rule information, domain information, history information, and other data.

The term “rule information” refers to data defining relationships, thresholds, or procedures used to interpret or process domain-specific information, including at least medical triage rules or commercial handling rules.

The term “domain information” refers to data associated with a particular application domain, such as healthcare or commerce, including knowledge bases, guidelines, manuals, and reference documents used in response generation.

The term “generative AI model” refers to a parameterized machine learning model that receives a prompt sentence as input and generates natural language text as output based on learned statistical patterns, including at least a model architecture of a neural network type.

The term “prompt sentence” refers to text data constructed by the server and input into the generative AI model, the text data including at least instructions, constraints, context information, and user-related content, and controlling generation behavior of the generative AI model.

The term “response sentence” refers to text data generated by the generative AI model in response to the prompt sentence, the text data representing an answer, an explanation, or guidance to be provided to the user.

The term “safety determination” refers to processing that evaluates whether the response sentence satisfies predetermined safety criteria, including at least checks for medically inappropriate content, harmful instructions, or policy-violating expressions.

The term “content formatting” refers to processing that restructures or reformats the response sentence into a layout suitable for presentation, such as inserting headings, bullet points, numbering, or other structural elements.

The term “post-processing” refers to processing applied to a response sentence after generation by the generative AI model, including at least safety determination, content formatting, and any modification or filtering of the response sentence.

The term “answer information” refers to structured data generated from a post-processed response sentence, including one or more components such as indicator information, support information, usage information, or inquiry response information, and formatted for delivery to the user terminal.

The term “indicator information” refers to data indicating a possibility or degree of risk of a specific condition, including at least an indicator of a potential epidemic disease based on aggregated symptom information.

The term “epidemic disease” refers to a disease that exhibits a tendency to spread among many individuals within a region or group within a relatively short period of time.

The term “support information” refers to information generated for assisting a human expert, including at least summaries, risk assessments, and candidate issues to be considered during a final diagnosis or expert review.

The term “final diagnosis” refers to a determination of a medical condition made by a medical specialist based on available information including system outputs, clinical judgment, and other medical data.

The term “usage information” refers to information describing how to use a product or service, including operational steps, precautions, recommended procedures, and example scenarios.

The term “inquiry response information” refers to information generated as an answer to a user's commercial or service-related question, including explanations, guidance, and references to applicable policies.

The term “character display function” refers to a function of outputting textual information on a visual display device, such as a screen, by rendering characters according to a user interface of the user terminal.

The term “speech synthesis function” refers to a function that converts text data into audio data representing artificial speech and outputs the audio data through an audio output device.

The term “output format” refers to a representation or structure of data suitable for presentation to the user, including at least a text format for display and an audio format for playback.

The term “history information” refers to stored data representing past interactions, including at least past input information, response sentences, answer information, and associated metadata for a session or a user.

The term “additional question” refers to a question generated by the server based on history information and intended to collect further information from the user or clarify previous input information.

The term “multi-turn dialog” refers to an interaction pattern in which the system and the user exchange a plurality of utterances over time, with each subsequent utterance being processed in view of preceding utterances.

The term “aggregate” refers to an operation that combines multiple data items, such as symptom information from multiple users, to compute collective statistics or patterns over a group.

The term “temporal transition” refers to a change of a value or pattern of data, such as symptom occurrence counts, over a time axis.

The term “regional distribution” refers to a spatial pattern of data, such as symptom occurrences, classified according to geographic regions or areas.

The term “sign of occurrence” refers to an indication, derived from analysis of aggregated data, that an event, such as an epidemic disease, may be emerging or increasing in a particular time period or region.

The term “emotion analysis function” refers to a software function configured to estimate an emotional state of a user or patient based on linguistic or paralinguistic features extracted from input information.

The term “emotional state” refers to a psychological condition inferred from the user's or patient's input, such as anxiety, calmness, distress, or satisfaction.

The term “evaluation result of the emotional state” refers to structured data representing an outcome of processing by the emotion analysis function, including, for example, an emotion category, a score, or a confidence value.

The term “medical specialist” refers to a human operator with professional qualifications in the healthcare field, such as a physician, nurse, or other licensed medical practitioner, who uses information provided by the system to perform a final diagnosis or treatment decision.

The term “human expert” refers to a human operator having expertise in a relevant domain, including at least a medical specialist in the healthcare field and a customer support professional in the commercial field.

The term “analysis result generated by the generative AI model” refers to information derived from or included in the response sentence, representing an interpretation, classification, or explanation produced by the generative AI model in response to the prompt sentence.

The term “detection result of the sign of occurrence of the epidemic disease” refers to data indicating an outcome of analysis on aggregated symptom information, including at least whether a sign of an epidemic disease has been detected and, optionally, an associated risk level or affected region.

In one embodiment, a server, a user terminal, and a communication network together implement the claimed system. The server includes at least one processor, a main memory, a non-transitory storage device, and a network interface. The server executes an operating system, such as a general-purpose server operating system, and application software implementing natural language processing, generative model interfacing, emotion analysis, and epidemic detection. The terminal includes a processor, a memory, a microphone, a speaker, a display, a wireless communication interface, and an operating system for executing an application that interacts with the server.

The terminal operates an application that allows a user to select a healthcare mode or a commercial mode, to input utterances via a touchscreen keyboard or a microphone, and to receive text or audio responses. The terminal uses a speech recognition service to convert captured audio signals, represented as digital time-series data, into text data. The terminal associates the text data with mode information, such as a code indicating “healthcare” or “commercial,” and identification information, such as a session identifier or device identifier, to generate structured communication data. The terminal transmits the communication data to the server via a secure communication protocol.

The server receives the communication data via the network interface. The server parses the communication data to obtain text data, mode information, and identification information.

The server stores these data items in a structured format in main memory and, if needed, in a relational database or a document database. The server applies natural language processing libraries, such as tokenizers and part-of-speech taggers, to segment the text data into tokens and to annotate linguistic attributes. The server then uses a Transformer-based intent classification model, such as a multi-layer self-attention network with positional encodings, to infer an intention label, such as “medical triage,” “product usage,” or “policy inquiry,” from an input vector sequence derived from the tokens.

The server uses an entity recognition model, which may be implemented as a neural sequence tagging model using a bidirectional Transformer encoder, to identify elements such as symptom names, durations, temperatures, product identifiers, and location names. The server encodes each token into an embedding vector, passes the vectors through stacked self-attention layers with residual connections, and outputs label probabilities for each token position. The server determines entity spans by selecting labels whose probabilities exceed threshold values. By performing this model-based extraction, the server reduces the need for manually written rules and improves consistency and coverage across varied input phrasing.

The server maps recognized symptom entities to internal symptom codes using a rule table stored in the storage device. Each entry in the rule table associates token-level patterns or normalized phrases with standardized symptom categories and severity levels. The server uses these mappings to transform free-text user descriptions into structured symptom information with defined attributes, including symptom type, duration, and intensity. The server similarly maps product names or identifiers to internal product records stored in a product database, which may contain usage instructions, warnings, and frequently asked questions.

The server determines a processing mode based on the intent label and the mode information from the terminal. When the server is in the healthcare mode, the server retrieves rule information from a medical rules repository. This rule information contains, for example, condition thresholds for fever duration, temperature values, and symptom combinations that correspond to risk levels of epidemic diseases. When the server is in the commercial mode, the server retrieves product or service information, including usage manuals, configuration guidelines, and policy documents, from a domain-specific repository.

The server generates a prompt sentence for a generative AI model by combining the intent label, the recognized entities, the structured symptom information or product information, and relevant conversation history. The server maintains conversation history in a session store as a sequence of records, each record including a user utterance, a machine response, a timestamp, and derived features such as intent and emotion classification results. The server selects a subset of the history according to heuristics that limit the total token length and preserve the most recent or most relevant exchanges. The server then constructs a prompt sentence in plain text form.

For example, when the user asks about product usage in the commercial mode, the server may generate a prompt sentence such as:

“You are a support assistant for consumer devices. The user asks how to use the product ‘Hair Dryer Model X100’. Based on the following product manual content: [manual excerpt], explain in clear, step-by-step instructions how to use this product safely and efficiently. Use short sentences and bullet points.”

When the user describes symptoms in the healthcare mode, the server may generate a prompt sentence such as:

“You are a virtual medical triage assistant. The patient reports: ‘fever of 38.5 degrees Celsius for three days and a dry cough’. Using the following symptom codes and rules: [symptom rule summary], ask up to five concise follow-up questions to better assess urgency, and indicate whether the patient should seek immediate in-person medical care, non-urgent consultation, or self-care. Do not provide a final diagnosis.”

The server further refines prompt sentences by including constraint conditions and style guidelines that control output length, level of detail, and prohibition of certain content. The prompt sentence may also incorporate indicator fields, such as a current regional epidemic risk score, that guide the generative model toward contextually appropriate responses without exposing internal logic directly to the user.

The server interfaces with a generative AI model through an application programming interface. The generative AI model may be implemented as a large-scale neural network with an encoder-decoder Transformer architecture or a decoder-only Transformer architecture.

The model receives the prompt sentence as a sequence of token embeddings and generates a response sentence token by token, using a self-attention mechanism to compute probability distributions over the vocabulary at each step. During inference, the server configures hyperparameters such as maximum token count, temperature, and top-k or top-p sampling thresholds to balance determinism and diversity.

The server does not treat the generative AI model as an opaque component. The server instead exploits the model's generative capacity under strict prompt control and integrates additional algorithmic layers for safety and domain-specific correctness. The server applies a separate classifier model, which can be a smaller Transformer network or a convolutional neural network, to the generated response sentence to detect categories of unsafe or inappropriate content, such as prohibited medical claims or unsafe product usage instructions.

The server also applies rule-based pattern checks that match specific phrases indicative of final diagnoses or absolute guarantees and replaces or removes such phrases in accordance with predefined policies.

The server formats the response sentence into answer information. When the system operates in the healthcare mode, the server computes indicator information representing a possibility of an epidemic disease. To compute this indicator information, the server retrieves aggregated symptom counts per time interval and region from a time-series database and applies statistical models, such as moving averages and anomaly detection algorithms, to identify deviations from baseline levels. The server uses the current user's symptom pattern and location to adjust the risk score and embeds the resulting indicator value in the answer information. The server also generates support information for a medical specialist, including a structured summary of symptoms, emotion analysis results, and relevant guideline identifiers.

When the system operates in the commercial mode, the server structures answer information into usage information or inquiry response information. The server parses the generated response sentence into segments, such as “step” sentences for procedures and “note” sentences for warnings, by matching simple linguistic patterns or by applying a lightweight segmentation model. The server stores these segments as entries in a structured document object that can be rendered as bullet lists or numbered lists on the terminal.

The server evaluates an emotional state of the user or patient by using an emotion analysis function. This function may employ a neural classifier that maps embeddings of the input text into emotion categories such as “anxious,” “calm,” or “angry.” The model architecture may include an embedding layer followed by a recurrent or Transformer-based encoder and a classification head that outputs probabilities for each emotion class. The server trains this model on labeled datasets of user utterances annotated with emotional labels, using a loss function such as cross-entropy and updating weights via stochastic gradient descent or a related optimization algorithm. During inference, the server uses the probabilities to assign an emotional state and a confidence score, and writes this evaluation result into both the answer information and the support information for the human expert.

The server aggregates symptom information from multiple users to detect signs of epidemic disease. For each time interval and region, the server stores a vector of symptom counts, such as counts of fever, cough, and sore throat. The server applies time-series analysis methods, such as exponentially weighted moving averages and threshold-based alerts, to identify disproportionate increases in symptom counts. The server then flags regions and time intervals with elevated risk levels and stores these flags as epidemic indicators. When a new user input arrives, the server consults these indicators to enhance risk-related guidance and to optimize resources such as triage prioritization.

The server stores history information for each session, including user inputs, generated response sentences, indicator values, emotion analysis results, and derived features such as intent labels and entity sets. The server uses this history to generate additional questions that are adapted to prior answers. For example, if a product usage explanation has already been given, the server avoids asking redundant clarifying questions by checking whether required features, such as product configuration and operating environment, have been collected. The server uses rule templates combined with generative sub-prompts to construct additional questions that fill missing fields in a predefined data schema. Because the server structures and reuses history in this way, the number of model invocations and the average token count per invocation are reduced, improving response time and reducing communication load.

The terminal receives answer information from the server and converts it into an output format. When the answer information includes text for display, the terminal renders the text on the display using a user interface framework. When the answer information includes audio content or when the user selects audio output, the terminal sends the text to a speech synthesis service, receives generated audio data, and outputs the audio via the speaker. The terminal also can display risk indicators or emotion-aware messages, such as highlighting urgent guidance with visual emphasis.

The server uses specific data structures and algorithmic flows that improve computer performance beyond simple automation of human tasks. For example, the server maintains a compact representation of conversation history, including token-level indices mapping between original text and semantic features. By reusing these indices in subsequent processing, the server avoids recomputing tokenization and entity recognition for unchanged text segments, thus lowering CPU utilization and processing latency. The server also uses batching strategies to process multiple user requests through shared neural inference pipelines, thereby utilizing hardware accelerators, such as graphics processing units, more efficiently and reducing per-request computation cost.

The server also implements non-conventional control of the generative AI model through adaptive prompt construction and feedback loops. The server records, for each prompt sentence and response sentence pair, metrics such as token counts, processing time, safety flags, and user feedback signals. The server uses these metrics to adjust subsequent prompt templates and parameter settings, for instance by shortening prompts in low-risk contexts or tightening safety constraints in high-risk contexts. This dynamic adaptation of prompts and parameters, guided by measurable system performance indicators, constitutes an improvement in the operation of the computer-based dialog system, leading to reduced latency, fewer unsafe outputs, and more stable behavior.

The server trains the generative AI model and the auxiliary models using supervised learning and, optionally, reinforcement learning. For supervised learning, the server stores training datasets in the storage device, including pairs of prompt sentences and target responses, symptom data and target risk labels, and user utterances and target emotion labels. The server defines loss functions, such as cross-entropy for token prediction and classification, and uses gradient-based optimization to update weight parameters. The server may employ regularization techniques, such as dropout in intermediate layers and weight decay, to prevent overfitting. The server may also perform data augmentation, such as paraphrasing of questions or noise injection into symptom descriptions, to enhance robustness. For reinforcement learning, the server may use reward signals derived from user satisfaction metrics or safety evaluation outcomes to fine-tune response strategies.

In another embodiment, the server adopts a different neural architecture, such as a sequence-to-sequence model with attention or a hybrid model combining rule-based components with neural components. In yet another embodiment, the server uses multiple generative AI models specialized for different domains and selects or ensembles their outputs based on the processing mode and confidence scores. The system can be deployed on a single physical server or on a distributed architecture comprising multiple server nodes, with load balancers, caching layers, and model-serving clusters.

The system thus uses a combination of specific data structures (such as structured conversation histories, symptom vectors, and risk indicators), specialized neural network architectures, and non-conventional prompt and post-processing logic to improve the speed, accuracy, and reliability of dialog handling. The server reduces redundant computation by caching intermediate analysis results, improves the quality of generative outputs by applying structured prompting and safety filtering, and enhances data management by representing user interactions, symptoms, and emotional states in reusable, standardized formats. As a result, the system achieves technical effects such as reduced processing latency, improved classification and triage precision, reduced error rates in product guidance, and lower network and compute resource usage per interaction, thereby improving computer technology itself rather than merely automating existing human workflows.

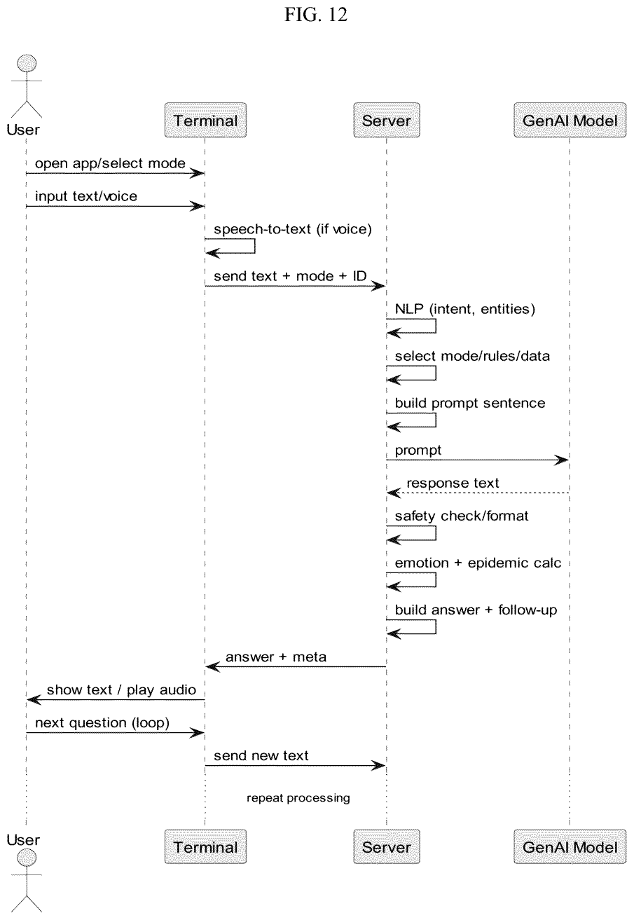

The following describes the processing flow using FIG. 12.

### Step 1:

The user operates the terminal to launch an application and select a processing mode such as a healthcare mode or a commercial mode.

The user inputs a query or symptom description to the terminal by speaking into a microphone or by typing text on a touchscreen keyboard.

The input of this step is raw user utterance data (audio waveform or typed characters), and the output is user input buffered in the terminal's memory as either audio data or character data.

### Step 2:

The terminal, when receiving audio data as input, digitizes the audio using an analog-to-digital converter and stores the resulting time-series audio samples in a buffer.

The terminal sends the buffered audio samples to a speech recognition service and receives text data as a transcription.

The input of this step is buffered audio data, and the output is text data representing the user's utterance.

### Step 3:

The terminal, when receiving typed text as input, stores the text directly into an internal text buffer without performing speech recognition.

The terminal normalizes the text by removing control characters and standardizing character encoding.

The input of this step is typed character data, and the output is normalized text data suitable for transmission.

### Step 4:

The terminal associates the normalized text data with mode information indicating whether the query is related to the healthcare field or the commercial field.

The terminal generates identification information such as a session identifier or device identifier and attaches the identification information to the text data and the mode information to form communication data.

The input of this step is normalized text data and application state, and the output is structured communication data including text, mode information, and identification information.

### Step 5:

The terminal establishes a secure communication channel to the server and transmits the communication data using a network protocol.

The terminal then waits for a response from the server while optionally displaying a status indicator to the user.

The input of this step is the structured communication data, and the output is a network request containing the communication data sent to the server.

### Step 6:

The server receives the network request via a network interface and parses the communication data to extract text data, mode information, and identification information.

The server stores the extracted data in a request object in memory and may log basic metadata in a storage device.

The input of this step is the received communication data, and the output is an internal request object containing separated text, mode, and identifiers.

### Step 7:

The server applies a tokenizer to the text data to split the text into tokens and encodes each token into an embedding vector.

The server uses an intent classification model to compute, from the embedding vectors, an intention label indicating a category such as “medical triage” or “product usage.”

The input of this step is the request text, and the output is an intent label and token embeddings representing the text.

### Step 8:

The server applies an entity recognition model to the token embeddings to detect entities such as symptom names, durations, measurements, product names, and location names.

The server aggregates tokens with entity labels into entity objects and normalizes them, for example by converting temperature strings into numerical values and standard units.

The input of this step is the sequence of token embeddings and model parameters, and the output is a structured set of entities with types and normalized values.

### Step 9:

The server determines a processing mode by combining the intent label with the mode information transmitted from the terminal.

The server selects a healthcare processing path when the mode is related to symptom information and a commercial processing path when the mode is related to product or service information.

The input of this step is the intent label and mode information, and the output is a processing mode flag that controls subsequent branches of the algorithm.

### Step 10:

The server, when the processing mode is healthcare, retrieves rule information for symptom interpretation from a medical rules repository using symptom codes derived from the entities.

The server, when the processing mode is commercial, retrieves domain information for product or service handling from a product or service database using product identifiers or names from the entities.

The input of this step is the processing mode and entity set, and the output is domain-specific information, such as rule information or product information, loaded into memory.

### Step 11:

The server accesses a session store using the identification information to retrieve conversation history associated with the current user or session.

The server selects a subset of past user utterances, system responses, and derived features according to a token budget or recency criteria to limit context size.

The input of this step is the identification information and stored session data, and the output is a summarized conversation history to be used as context.

### Step 12:

The server generates a prompt sentence for a generative AI model by combining the current text data, the intent label, the entity set, the domain-specific information, and the conversation history.

The server inserts explicit instructions and constraints into the prompt sentence, such as “do not provide a final diagnosis” or “use step-by-step instructions,” to guide the model's output.

The input of this step is the analysis result (intent and entities), the domain-specific information, and the context history, and the output is a constructed prompt sentence in text form.

### Step 13:

The server, in a commercial usage scenario, may generate a prompt sentence such as: “You are a support assistant for consumer devices. The user asks how to use the product ‘Hair Dryer Model X100’. Based on the following product manual content: [manual excerpt], explain in clear, step-by-step instructions how to use this product safely and efficiently. Use short sentences and bullet points.”

The server, in a healthcare triage scenario, may generate a prompt sentence such as: “You are a virtual medical triage assistant. The patient reports: ‘fever of 38.5 degrees Celsius for three days and a dry cough’. Using the following symptom codes and rules: [symptom rule summary], ask up to five concise follow-up questions to better assess urgency, and indicate whether the patient should seek immediate in-person medical care, non-urgent consultation, or self-care. Do not provide a final diagnosis.”

The input of this step is the selected scenario and underlying data, and the output is an appropriately tailored prompt sentence including example structures.

### Step 14:

The server tokenizes the prompt sentence according to the vocabulary of the generative AI model and maps tokens to integer indices.

The server sends the sequence of indices, along with generation parameters such as maximum length and sampling settings, to the generative AI model through an inference interface.

The input of this step is the text prompt sentence, and the output is a tokenized prompt and a request to the generative AI model.

### Step 15:

The server receives from the generative AI model a sequence of output token indices representing a generated response sentence.

The server converts the token indices back into characters and words to reconstruct the response sentence in natural language.

The input of this step is the generated token sequence from the generative AI model, and the output is a raw response sentence as text data.

### Step 16:

The server applies a safety determination process to the raw response sentence by running a safety classifier that assigns categories such as “safe,” “requires modification,” or “reject.”

The server inspects the response sentence against rule-based patterns to detect prohibited medical claims, unconditional guarantees, or dangerous product instructions and marks parts that violate policies.

The input of this step is the raw response sentence and predefined safety rules, and the output is a safety-evaluated response with annotations indicating unsafe segments or categories.

### Step 17:

The server performs content formatting on the response sentence by adding structural markers such as headings, bullet symbols, or numeric prefixes for steps, based on linguistic patterns or embedded markers.

The server converts the formatted response into answer information, which may include separate fields for step-by-step instructions, warnings, suggested next actions, and, in the healthcare mode, indicator fields for epidemic risk.

The input of this step is the safety-evaluated response sentence, and the output is structured answer information suitable for presentation and further processing.

### Step 18:

The server runs an emotion analysis function on the original user text by feeding token embeddings into an emotion classification model.

The server computes probabilities for emotion categories and selects an emotional state label and confidence score, which are then attached to the answer information and stored for expert reference.

The input of this step is the user text and model parameters, and the output is an emotional state evaluation result associated with the interaction.

### Step 19:

The server updates aggregate symptom statistics by incrementing counters for symptoms present in the entity set, grouped by time interval and region.

The server recalculates epidemic indicators, such as anomaly scores for symptom patterns, and updates risk levels stored in an epidemic indicator table.

The input of this step is the structured symptom information and location data, and the output is updated aggregate statistics and epidemic risk indicators.

### Step 20:

The server updates conversation history in the session store by appending a record containing the user input, the response sentence, the intent label, the entity set, the emotional state, and any computed risk indicators.

The server derives a set of missing information items based on rules or schemas and, if needed, constructs an additional question to be asked in the next turn.

The input of this step is the current interaction data, and the output is an updated history record and, optionally, a candidate additional question text.

### Step 21:

The server packages the answer information, together with any additional question, into a response object including display text, metadata fields, and flags indicating urgency or commercial importance.

The server transmits the response object to the terminal via the communication network.

The input of this step is the structured answer information and metadata, and the output is a network response containing data to be rendered on the terminal.

### Step 22:

The terminal receives the response object and parses it to separate display text, audio text, and control flags.

The terminal renders the display text on the screen, using different visual styles for normal information, warnings, and urgent instructions based on the flags.

The input of this step is the response object, and the output is visual content presented to the user on the display.

### Step 23:

The terminal, when audio output is enabled, sends the audio text portion of the answer information to a speech synthesis service and receives synthesized audio data.

The terminal plays back the audio through a speaker or a connected audio device, thereby delivering the response in voice form to the user.

The input of this step is text designated for speech output, and the output is audio playback of the synthesized response.

### Step 24:

The user reviews the displayed information or listens to the audio output and decides whether the answer is sufficient or whether a follow-up query is needed.

The user, if more information is desired or if prompted by an additional question from the server, inputs a new utterance, causing the terminal and server to repeat the above steps in a multi-turn dialog flow.

The input of this step is the presented answer and any additional question, and the output is a new user utterance that initiates the next cycle of processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional computer-implemented medical interview systems, natural language symptom inputs from users are typically stored and processed in a simple rule-based or keyword-matching manner. Such systems suffer from several technical limitations in terms of information processing on general-purpose computing hardware. First, because the symptom text is not structurally enriched and is handled as unrefined free text, it is difficult for a processor to accurately relate user-reported symptoms to dynamically changing epidemic disease information stored in a database. This leads to inefficient database searches, suboptimal similarity computations, and increased processing load when the number of records and disease types grows.

Second, conventional systems do not coordinately utilize a generative AI model and local natural language processing logic in a feedback manner. The generative AI model, if used, is often invoked in an ad hoc way, with static prompts that do not depend on structured similarity results or epidemic context computed on the server side. As a consequence, the processor cannot leverage the generative AI model to refine its own preprocessing conditions, similarity thresholds, or question-generation strategy, resulting in suboptimal overall analysis accuracy and inefficient use of computational resources.

Third, most existing systems do not integrate emotion analysis results, obtained from patient input, into the same structured data pipeline that handles symptom extraction and epidemic candidate selection. Emotion evaluation, if performed at all, is typically treated as a separate downstream step. This separation makes it difficult for the processor to store, associate, and present emotion evaluation in a unified medical support output, which reduces the effectiveness of the interface for medical workers and can complicate the logic for prioritizing or triaging cases on the basis of both clinical and emotional risk factors.

Fourth, in distributed environments where terminals and servers interact, conventional implementations generally treat the interview dialog, symptom extraction, and AI-based analysis as loosely coupled components. The lack of a unified server-side control flow that (i) acquires user input via a dialog interface, (ii) performs standardized natural language preprocessing, (iii) performs structured similarity computation with epidemic disease information, (iv) generates prompt sentences that explicitly encode these structured results for a generative AI model, and (v) returns a consolidated medical support output for medical workers, leads to increased implementation complexity, higher communication overhead, and difficulty in scaling the system to large volumes of concurrent interviews.

Accordingly, there is a need for an improved computer-implemented system and method that, on a processor of a server, standardizes and coordinates (a) dialog-based symptom acquisition from a terminal, (b) natural language preprocessing and symptom-term extraction, (c) similarity-based pickup of epidemic disease candidates from stored epidemic information, (d) prompt sentence generation and interaction with a generative AI model for detailed analysis and for tuning natural language processing conditions, and (e) emotion analysis and unified presentation of medical support information to medical workers. Such a system should improve the efficiency and accuracy of text processing, similarity computation, and AI invocation on general-purpose computing hardware, thereby concretely improving the functioning of the computer system itself in performing medical decision support tasks.

The specific processing by the specific processing unit 290 of the data processing device 12 in Example 2 is realized by the following means.

The present invention provides a server comprising a processor and a storage device, the processor being configured to control a dialog-based interview process with a terminal device to acquire, from a user, input information including symptom information; to store the acquired input information in the storage device; to preprocess the stored input information by using a language processing program having a natural language processing function to extract symptom-related terms from the input information; to read, from the storage device, information groups relating to epidemic diseases including symptom information for each disease; to calculate, by using the language processing program or a similarity calculation program, a similarity between the symptom-related terms extracted from the input information and the symptom information of each epidemic disease; to extract, based on the calculated similarity, candidates for epidemic diseases; to generate, based on the candidates for epidemic diseases and the input information, a prompt sentence as an analysis request instruction text describing symptom information to be analyzed and the candidates for epidemic diseases; to input the prompt sentence into a generative AI model and request detailed analysis by the generative AI model; to acquire an analysis result output from the generative AI model; to generate medical support information including diagnosis candidates, differential candidates, and additional inquiry items based on the analysis result, the candidates for epidemic diseases, and the input information; to present the medical support information to a medical worker; and to evaluate an emotional state of a patient by using an emotion analysis program that performs emotion analysis processing based on the input information of the patient, associate an evaluation result of the emotional state with the medical support information, and present the evaluation result of the emotional state to the medical worker so as to support reflection of the evaluation result of the emotional state in a final diagnosis. This enables the server to implement, on general-purpose computing hardware, a coordinated processing pipeline in which symptom text is converted into structured features, matched efficiently against epidemic disease information, encoded into context-rich prompt sentences for the generative AI model, and integrated with emotion analysis results, thereby improving the accuracy, efficiency, and scalability of computer-implemented medical decision support and enhancing the technical performance of the underlying information processing system.

The term “system” refers to an integrated combination of hardware and software components, including at least one server, at least one terminal device, and associated programs, that cooperatively execute the processing described in the claims.

The term “processor” refers to a hardware computing element, such as a central processing unit or other arithmetic and logic execution unit, that executes machine-readable instructions to implement the claimed functions.

The term “terminal device” refers to an information processing apparatus operated by a user, such as a portable communication device, a personal computer, or a tablet device, that transmits input information to the server and presents information received from the server.

The term “user” refers to a human operator who provides input information, including symptom information, to the system via a terminal device.

The term “input information” refers to data provided by the user through the terminal device, including at least symptom information and optionally background information such as duration, severity, and related contextual information.

The term “symptom information” refers to natural language expressions or structured data that describe physical, mental, or physiological conditions experienced by the user or patient.

The term “dialog-based interview process” refers to an interactive communication sequence in which the server exchanges messages with the user through the terminal device in a conversational format to acquire and refine input information.

The term “storage device” refers to a hardware or virtualized memory resource, such as a non-volatile storage unit or database system, that stores the input information, epidemic disease information, analysis results, and related data.

The term “language processing program” refers to software that implements natural language processing functions, including tokenization, normalization, extraction of key terms, and analysis of textual content.

The term “natural language processing function” refers to a set of computational operations that enable a processor to interpret, analyze, and transform text expressed in a human language.

The term “symptom-related terms” refers to tokens, keywords, or linguistic units extracted from the input information that represent or indicate symptoms or clinical features.

The term “information groups relating to epidemic diseases” refers to collections of data records stored in the storage device that describe diseases with epidemic characteristics, including at least symptom descriptions and optionally regional or temporal attributes.

The term “epidemic disease” refers to a disease type for which increased incidence has been observed or is being monitored in a particular population, region, or period.

The term “symptom information for each disease” refers to textual or structured data that characterize the typical or known symptoms associated with a given disease.

The term “similarity calculation program” refers to software that computes a similarity measure between sets of terms or feature representations derived from symptom information of the user and symptom information of diseases.

The term “similarity” refers to a quantitative or qualitative measure indicating the degree of correspondence between symptom-related terms extracted from the input information and symptom information associated with epidemic diseases.

The term “candidates for epidemic diseases” refers to a subset of epidemic diseases selected based on the similarity between the user's symptom-related terms and the symptom information of the diseases.

The term “prompt sentence” refers to an instruction text generated by the processor that describes analysis targets and contextual information, and that is input to a generative AI model to request a specific analysis or output.

The term “analysis request instruction text” refers to a prompt sentence that explicitly directs the generative AI model to perform a designated analysis task based on provided symptom information and disease candidates.

The term “generative AI model” refers to an artificial intelligence model that generates text or other outputs in response to input data and prompt sentences, using machine-learned parameters obtained from training on large-scale datasets.

The term “detailed analysis” refers to an output from the generative AI model that includes evaluations of possible diseases, reasoning or explanation of such evaluations, and recommendations for additional information or inquiries.

The term “analysis result” refers to data returned from the generative AI model in response to a prompt sentence, including at least inferred diagnoses, differential considerations, or suggested questions.

The term “medical support information” refers to structured or semi-structured information generated by the processor that includes at least diagnosis candidates, differential candidates, and additional inquiry items for use by a medical worker.

The term “diagnosis candidates” refers to one or more diseases or clinical conditions proposed as possible explanations for the symptom information of the patient.

The term “differential candidates” refers to alternative diseases or clinical conditions that are considered in distinguishing among possible diagnoses for the patient.

The term “additional inquiry items” refers to questions or data items suggested for collection from the user or patient in order to refine the diagnostic assessment or risk evaluation.

The term “medical worker” refers to a person having medical expertise, such as a physician, nurse, or other healthcare professional, who uses the medical support information to perform or assist in final diagnosis.

The term “emotion analysis program” refers to software that processes input information from the patient to estimate an emotional state, such as anxiety, distress, or calmness, using text analysis, classification, or other computational methods.

The term “emotion analysis processing” refers to computational operations performed on input information to derive indicators or metrics representing the emotional state of the patient.

The term “emotional state” refers to a mental or affective condition of the patient, such as fear, anxiety, sadness, or relief, inferred from the patient's input information.

The term “evaluation result of the emotional state” refers to one or more values, labels, or descriptors that represent the outcome of the emotion analysis processing for the patient.

The term “final diagnosis” refers to a diagnostic conclusion or decision made by the medical worker regarding the patient's condition, which may be informed by the analysis result of the generative AI model, the candidates for epidemic diseases, and the evaluation result of the emotional state.

The term “analysis policy” refers to rules, parameters, or strategies that govern how the language processing program or the generative AI model performs analysis on input information.

The term “auxiliary information” refers to additional data, hints, or settings produced by the generative AI model that can be used to adjust or optimize natural language processing conditions or similarity calculations.

The term “execution conditions of the natural language processing” refers to configurable parameters or settings, such as tokenization methods, extraction thresholds, or similarity metrics, that determine how the language processing program operates on text.

The term “diagnosis support proposals” refers to suggestions provided by the generative AI model to assist the medical worker in conducting a diagnosis, including recommended diagnostic paths, prioritizations, or decision points.

The term “additional input items” refers to further data fields or questions recommended by the generative AI model for collection from the user or patient to improve the reliability of diagnosis or analysis.

The term “alert information” refers to notifications or warnings generated or relayed by the generative AI model that indicate potential urgency, high risk, or the need for immediate medical attention.

In one embodiment, a server implements the claimed system by executing machine-readable instructions on a general-purpose processor. The server is connected to one or more terminal devices operated by users and medical workers via a communication network, such as the Internet, using standard communication protocols including HTTPS over TCP/IP. The server includes a central processing unit, a main memory, a non-volatile storage device, and network interface hardware. The server executes an operating system such as a general-purpose server operating system and runs application software implemented, for example, in a high-level programming language with frameworks for web applications and data processing.

The server uses a relational database management system, such as a general-purpose relational database engine, installed on the storage device, to store user input information, epidemic disease information, natural language processing results, generative AI analysis results, and emotion analysis results. The server defines multiple database tables, including an interview session table, an input information table, an epidemic disease table, a feature representation table, an AI request table, and an AI analysis result table. Each table stores records with defined fields such as user identifiers, timestamps, text fields, token lists, vector representations, similarity scores, and diagnosis candidate lists. These tables form specific data structures that enable efficient indexing and retrieval based on user, time, and disease identifiers.

The terminal operates as a client device that presents a dialog-based interview interface to the user. The terminal may be a smartphone, a tablet device, or a personal computer. The terminal executes client-side software, such as a web browser or a native application, that renders a user interface implemented in markup language, style sheets, and client-side scripting language. The terminal sends user-entered text, including symptom descriptions and responses to questions, to the server as structured data, for example, in a key-value representation over an application-level protocol. The terminal also receives formatted medical support information and displays it to medical workers or users in a human-readable form.

The user operates the terminal to input symptom information and related context in a natural language. The user may type free-text sentences describing physical or mental conditions, such as “Recently, I have had a cough and fever.” The user optionally provides additional structured fields, such as age, duration of symptoms, and geographical region. The terminal converts these inputs into structured request messages and transmits them to the server.

The server stores the raw input information received from the terminal in the database. The server associates each piece of input information with a unique session identifier and user identifier. The server maintains an input information record that includes fields such as raw_symptom_text, language_code, region_code, and created_at. The server also records the dialog context, including previously asked questions and user responses, to support multi-turn interviews.

The server executes a language processing program implemented, for example, using a natural language processing library or toolkit. The server loads the raw_symptom_text from the database into main memory and tokenizes the text into discrete lexical units. The server performs normalization operations, such as converting characters to lower case, removing punctuation, and applying stemming or lemmatization algorithms to map inflected forms to base forms. The server uses a stop-word list to remove function words and non-informative tokens, and retains terms that are likely to correspond to symptoms, body parts, durations, and intensity descriptors. The server may additionally apply part-of-speech tagging and named entity recognition to identify medically relevant entities such as symptom names and disease names.

The server converts the extracted symptom-related terms into a numeric feature representation. In one embodiment, the server uses a term-frequency or term-frequency-inverse-document-frequency vector representation. The server maintains a term dictionary or vocabulary that is built from historical user inputs and epidemic disease symptom descriptions. The server uses a general-purpose machine learning library to compute a feature vector for the user's input, where each dimension corresponds to a term in the vocabulary and the vector components represent normalized term weights.

The server stores epidemic disease information in the database in a structured form. Each disease record includes a disease identifier, a disease name, a symptom_description_text, a region_code, a current_incidence_level, and validity periods. The server preprocesses the symptom_description_text fields for each disease using the same language processing program and feature representation as for the user's input. The server stores the resulting feature vectors in a feature representation table, indexed by disease identifier. This precomputation allows the server to avoid repeated tokenization and feature computation for each request, thereby reducing processing latency and improving computational efficiency.

The server retrieves, from the database, the feature vector corresponding to the user's input and the feature vectors corresponding to epidemic diseases that are active in the user's region and time period. The server uses a similarity calculation program implemented, for example, using a numerical computation library, to compute similarity scores between the user vector and each disease vector. The server may use cosine similarity, Jaccard similarity, or other vector-based metrics. The server stores computed similarity scores temporarily in memory or in a dedicated table and selects diseases whose similarity scores exceed a predefined threshold or belong to the top ranks. These selected diseases constitute the candidates for epidemic diseases.

The server generates a prompt sentence that encodes both the raw symptom information and the structured similarity results. The server uses a template-based method in which predefined text templates contain placeholders for user-reported symptoms, region information, candidate disease names, and similarity labels such as “high similarity” or “moderate similarity.” The server fills these placeholders with actual values from the database records. An example of such a prompt sentence is:

“The user reports: ‘Recently, I have had a cough and fever.’ Current epidemic data for the region show active influenza and COVID-19. Symptoms of influenza include sudden fever, cough, sore throat, and fatigue. Symptoms of COVID-19 include fever, cough, loss of smell, and shortness of breath. As a generative AI model, analyze whether the user's symptoms are more consistent with influenza, COVID-19, or another condition. Provide a ranked list of possible diagnoses, your reasoning, and at least five follow-up questions that a physician should ask.”

In another example, the server generates a prompt sentence focused on a single candidate disease:

“The user reports: ‘Recently, I have had a cough and fever.’ Current epidemic data for the user's region show a high incidence of influenza, which typically presents with sudden fever, cough, sore throat, and fatigue. Analyze whether the user's condition is consistent with influenza, provide a confidence assessment, list alternative conditions, and suggest additional questions to distinguish them.”

The server sends the prompt sentence to a generative AI model via an application programming interface. In one embodiment, the generative AI model is a transformer-based neural network model with multiple self-attention layers, feed-forward layers, and normalization layers. The model parameters include weight matrices and bias terms learned from large-scale corpora using a pretraining procedure based on masked language modeling and next-token prediction. The server specifies, in the API request, the prompt sentence, a model name, and generation parameters such as maximum output length, temperature, and top-k or nucleus sampling thresholds.

The server receives from the generative AI model a text output that represents a detailed analysis result. Internally, the generative AI model processes the prompt sentence by converting each token into an embedding vector, applying multi-head self-attention operations, and propagating activations through a stack of transformer blocks. The model computes a probability distribution over the vocabulary for each successive output token and generates a sequence of tokens until a termination condition is met. Because the server controls parameters such as maximum tokens and sampling distribution, the server can adjust the trade-off between computational cost and output richness.

The server parses the analysis result and, in some embodiments, applies post-processing rules to extract structured elements such as a ranked list of diagnosis candidates, differential candidates, recommended follow-up questions, and alert conditions. The server may use regular expressions, pattern matching, or additional language processing to identify enumerated lists and labeled sections in the generative AI output. The server then stores the raw analysis text and the extracted structured data in the AI analysis result table.

In one embodiment, the server further uses the generative AI model to refine its own natural language processing conditions. The server constructs a separate prompt sentence that describes the current preprocessing pipeline and asks for improved parameters or strategies such as term selection thresholds, synonym handling rules, or weighting of certain symptom terms. The server receives the generative AI output describing analysis policies or auxiliary information and updates its configuration parameters stored in a settings table. This closed-loop interaction enables the server to adapt tokenization thresholds, similarity thresholds, and question generation strategies in response to changing language patterns and epidemic conditions, resulting in improved accuracy and stability of the processing pipeline.

The server executes an emotion analysis program to evaluate the emotional state of the patient based on the input information. The emotion analysis program may use a supervised learning classifier, such as a neural network or other machine learning model trained to map text embeddings to emotion labels. For example, the server may use a recurrent or transformer-based classifier that takes as input token sequences from the patient's statements and produces scores for emotion categories such as “anxiety,” “fear,” “anger,” or “calm.” The server trains this classifier using historical labeled data, updating model weights by minimizing a cross-entropy loss function and applying gradient-based optimization. The server stores the resulting emotion probabilities and labels as the evaluation result of the emotional state.

The server associates the emotion evaluation result with the medical support information. The server defines a data structure in which each interview session record links to both clinical analysis results and emotional analysis results. The server computes a composite priority score, for example, by combining similarity-based risk indicators with emotion-based urgency indicators. This composite score can be used to sort or filter cases for review by medical workers, enabling the server to reduce the time to detect high-risk or high-distress cases and to optimize resource allocation.

The server presents medical support information and emotion evaluation results to a medical worker's terminal. The server generates a structured display that includes the user's original symptom text, the candidate epidemic diseases with similarity scores, the ranked diagnosis candidates and differential candidates from the generative AI model, the recommended follow-up questions, and the emotion analysis results. The terminal renders this display in a layout that clearly distinguishes system-generated suggestions from user inputs. The medical worker can quickly scan highlighted risks and key questions, which reduces cognitive load and allows more efficient case assessment compared to reviewing raw free-text only.

The server's specific data structures and algorithmic flow provide concrete technical improvements over conventional systems. By precomputing disease feature vectors and storing them in the database, the server reduces the number of repeated tokenization and feature extraction operations, thereby improving processing speed and reducing CPU utilization. By using similarity measures on vector representations instead of naive string matching, the server improves matching accuracy and robustness to variations in user input text, which reduces false matches and increases diagnostic relevance. By encoding structured similarity results into prompt sentences, the server supplies a generative AI model with richer context and constraints, leading to more focused and efficient generation, which in turn reduces network bandwidth usage and response latency.

The server's integration of an emotion analysis program with the symptom-based analysis further enhances triage efficiency. Rather than serving merely as an automated clerk, the system reorganizes data for the medical worker in a way that a human, unaided by the described algorithms and data structures, could not practically replicate at scale or speed. The use of specific feature vectors, similarity metrics, and configuration feedback from the generative AI model transforms free-text into machine-optimal representations, demonstrating an improvement in computer functionality in the domains of text analysis, retrieval, and decision support.

In an alternative embodiment, the server may execute the generative AI model locally on dedicated hardware, such as a graphics processing unit or specialized accelerator. In that case, the server loads model parameters from local storage and performs inference using optimized linear algebra libraries. The server may quantize weights or use model distillation to reduce memory consumption and improve inference speed. These techniques further reduce network dependency and increase robustness.

In another embodiment, the server may use a different similarity calculation algorithm, such as approximate nearest neighbor search in an embedding space, combined with a vector index structure. The server may encode both user inputs and disease descriptions into dense vector embeddings computed by a sentence encoder model. The server stores these embeddings in a vector index and performs approximate nearest neighbor search to identify candidate diseases. This configuration improves scalability when the number of diseases or symptom patterns becomes large.

In a further embodiment, the server may support multiple languages by maintaining separate vocabularies and models for each language, or by translating user inputs into a common internal language using a machine translation module. The server then applies the same feature extraction, similarity calculation, prompt generation, and emotion analysis pipeline to the translated text. This allows the system to operate consistently across multilingual environments without duplicating all downstream logic.

The terminal may incorporate additional local pre-processing, such as client-side input validation and local symptom suggestion lists, to reduce network round trips and ease server load. For example, the terminal may locally expand abbreviations or correct spelling based on a local dictionary before transmitting text to the server. This reduces the burden on the server's language processing program and improves overall throughput.

Through these embodiments, the server, terminal, and user cooperate in an integrated technical solution that enhances the functioning of computer systems in medical decision support. The system's specific architecture, data structures, and algorithmic flow produce improvements in processing accuracy, speed, and resource consumption, and the combined use of similarity-based candidate selection, structured prompt sentence generation, transformer-based generative AI modeling, and emotion analysis results in a technical effect that goes beyond mere automation of a human workflow.

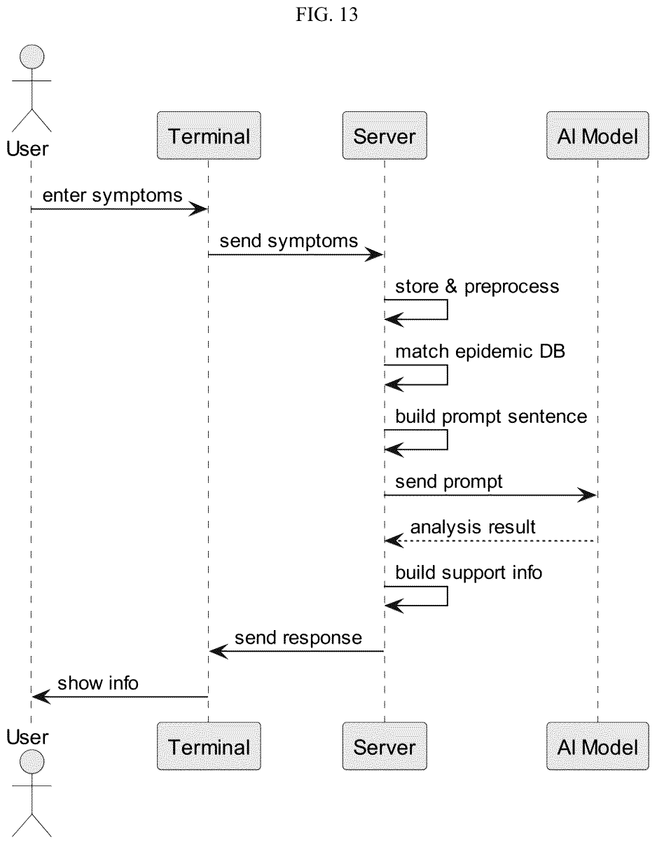

The following describes the processing flow using FIG. 13.

### Step 1:

The user operates the terminal to start an interview session. The user inputs initial symptom information in natural language, such as “Recently, I have had a cough and fever,” into a dialog-based interface displayed on the terminal.

Input: user's free-text symptom description and basic profile information (for example, age, region).

Output: a structured request message containing the text, user identifier, and session start instruction, which the terminal prepares for transmission.

The terminal converts the user's input into a structured data object including fields such as user_id, raw_symptom_text, region_code, and sends this object to the server via a secure network connection.

### Step 2:

The server receives the structured request message from the terminal. The server verifies the message format, authenticates the user identifier if necessary, and creates a new interview session record in a database.

Input: structured request message including user_id, raw_symptom_text, region_code, and a session start flag.

Output: a new interview_session_id stored in a session table and a confirmation response sent back to the terminal.

The server writes a row into an interview session table with fields such as session_id, user_id, start_timestamp, and status. The server returns the generated session_id to the terminal for use in subsequent communications.

### Step 3:

The terminal receives the session identifier from the server and continues the dialog. The terminal displays a confirmation to the user and may present an additional question, such as “Please describe when your symptoms started.”

Input: session_id and any initial instructions from the server.

Output: updated user responses provided through the UI and packaged into subsequent request messages.

The user types further details (for example, “The symptoms started three days ago”), and the terminal associates this new text with the same session_id, then transmits it to the server.

### Step 4:

The server stores all received input information for the session. The server accumulates the user's raw symptom texts and structured answers in an input information table.

Input: messages from the terminal containing session_id, user_id, and free-text symptom entries.

Output: persistent records in an input information table containing raw_symptom_text, timestamp, and dialog turn identifiers.

The server executes database insert operations to append each new message to the session, thereby creating a chronological record of the dialog for later analysis.

### Step 5:

The server executes a language processing program to preprocess the accumulated input information. The server loads the latest raw_symptom_text for the session from the database into memory and tokenizes the text into words or subword units.

Input: raw_symptom_text associated with the session.

Output: a set of normalized symptom-related tokens stored in memory or in a token table.

The server performs lowercasing, punctuation removal, lemmatization or stemming, and stop-word filtering. The server then selects medically relevant tokens (for example, “cough,” “fever,” “three days”) and stores them as symptom-related terms that will be used for similarity computation.

### Step 6:

The server converts the symptom-related terms into numeric feature vectors. The server references an existing vocabulary and weighting model (for example, a term-frequency-inverse-document-frequency model) and maps each term to an index and weight.

Input: list of normalized symptom-related terms for the session.

Output: a numeric feature vector representing the user's symptom description.

The server computes term weights based on term frequency and global inverse-document statistics, performs vector normalization (such as L2 normalization), and stores the resulting feature vector in a feature representation table linked to the session id.

### Step 7:

The server retrieves epidemic disease information from the database for comparison. The server filters disease records by region_code and validity period so that only relevant epidemic diseases are selected.

Input: region_code and a disease table containing disease identifiers, symptom_description_text, region_code, and incidence information.

Output: a list of relevant epidemic disease records and their precomputed feature vectors.

The server loads the precomputed feature vectors associated with each selected disease from a feature representation table, avoiding repeated text preprocessing for each request.

### Step 8:

The server calculates similarity between the user's feature vector and each disease feature vector. The server uses a similarity calculation program that performs a numeric operation such as cosine similarity over the vectors.

Input: user feature vector and a set of disease feature vectors.

Output: a list of similarity scores, each associated with a disease identifier.

The server multiplies vector components, sums the products, and divides by the product of vector norms to compute cosine similarity. The server then orders diseases by similarity score and selects those above a threshold or within the top ranks as candidates for epidemic diseases.

### Step 9:

The server constructs a list of candidates for epidemic diseases. The server enriches each candidate with metadata such as disease name, incidence level, and key symptom descriptors.

Input: ordered similarity score list and disease metadata from the database.

Output: a candidate list containing disease identifiers, names, similarity scores, and brief symptom summaries.

The server writes this candidate list into a candidate disease table associated with the session_id and makes the list available for subsequent prompt generation.

### Step 10:

The server generates a prompt sentence for a generative AI model based on the user's symptom information and the candidate diseases. The server uses a template that includes placeholders for the user's raw text, region data, names of candidate diseases, and their characteristic symptoms.

Input: raw_symptom_text from the session, candidate disease list, and epidemic metadata.

Output: a completed prompt sentence text that encodes the analysis request.

The server inserts values such as “cough and fever,” “influenza,” and “COVID-19” into the template. An example generated prompt sentence is:

“The user reports: ‘Recently, I have had a cough and fever.’ Current epidemic data for the region show active influenza and COVID-19. Symptoms of influenza include sudden fever, cough, sore throat, and fatigue. Symptoms of COVID-19 include fever, cough, loss of smell, and shortness of breath. As a generative AI model, analyze whether the user's symptoms are more consistent with influenza, COVID-19, or another condition. Provide a ranked list of possible diagnoses, your reasoning, and at least five follow-up questions that a physician should ask.”

The server stores this prompt sentence in an AI request table with a reference to the session id.

### Step 11:

The server sends the prompt sentence to the generative AI model via an application programming interface. The server constructs a request payload including the prompt sentence, model identifier, and generation parameters.

Input: prompt sentence text, model name, and generation configuration (such as maximum tokens, temperature).

Output: a request message transmitted to the generative AI model and a corresponding pending state in the AI request table.

The server uses an HTTP client to send the request over a secure connection, then waits for a response, applying timeout and retry logic if necessary.

### Step 12:

The server receives the response from the generative AI model. The server extracts the generated analysis text from the response payload.

Input: response data from the generative AI model, including generated text.

Output: an analysis_result_text stored in an AI analysis result table.

The server parses the response structure, logs relevant metadata (such as model version and token usage), and associates the analysis_result_text with the original session_id and prompt request.

### Step 13:

The server post-processes the analysis_result_text to extract structured information. The server searches for patterns indicating diagnosis candidates, differential diagnoses, follow-up questions, and alert conditions.

Input: analysis_result_text for the session.

Output: structured items such as a ranked list of diagnosis candidates, a list of differential candidates, and a set of recommended questions.

The server applies rule-based extraction, for example detecting numbered lists or phrases like “Diagnosis 1:” or “Question:”. The server then stores each extracted element in dedicated fields or tables for later presentation to medical workers.

### Step 14:

The server executes an emotion analysis program on the user's input information. The server aggregates the user's text contributions for the session and converts them into a sequence of tokens or embeddings suitable for an emotion classification model.

Input: all raw_symptom_text entries and dialog responses from the session.

Output: an emotion evaluation result containing emotion labels and associated scores.

The server feeds the input sequence into a trained classifier, obtains emotion probabilities for categories such as anxiety or distress, and stores the resulting labels and scores in an emotion result table linked to the session_id.

### Step 15:

The server generates medical support information for a medical worker. The server combines the user's original symptom text, candidate epidemic diseases, structured diagnosis candidates, differential candidates, follow-up questions, and emotion evaluation results into a unified data structure.

Input: candidate disease list, structured AI analysis results, emotion evaluation results, and raw_symptom_text.

Output: a medical support record containing summarized and structured information for display.

The server builds a data object that organizes items into sections (for example, “User report,” “Epidemic candidates,” “AI-ranked diagnoses,” “Recommended questions,” “Emotion assessment”), stores this object, and prepares it for rendering.

### Step 16:

The server provides the medical support information to a terminal used by a medical worker.

The server formats the data for display, for example, as a markup-based page or structured view.

Input: medical support record associated with a particular session_id and medical worker request parameters (such as filter or sort options).

Output: a rendered view or structured response containing all relevant support information.

The terminal receives the formatted data, displays symptom text, candidate diseases, AI analysis summaries, and emotion scores, and allows the medical worker to review these elements in a compact, ordered layout.

### Step 17:

The medical worker interacts with the terminal to review and optionally refine the case. The medical worker reads the provided medical support information, considers the ranked diagnoses and follow-up questions, and may decide to ask the user additional specific questions or to schedule further examinations.

Input: displayed medical support information and any additional query inputs entered by the medical worker.

Output: refined instructions, new questions, or decisions recorded in the system as additional records.

The terminal sends any new inputs from the medical worker back to the server, and the server logs them and may trigger additional analysis cycles if required, thereby closing the loop between generative AI analysis, symptom evaluation, and final diagnostic support.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented triage and decision-support systems typically use rule-based engines or single-pass natural language processing to parse patient input and to generate static questionnaires. Such systems suffer from several technical limitations. First, they are unable to flexibly adapt their question flow based on the evolving dialog context, resulting in incomplete or noisy structured data being stored in memory and databases.

Second, they generally treat all user text as homogeneous data and do not separate symptom-related content from emotion-related content at the algorithmic level, which leads to sub-optimal feature representations for downstream processing. Third, existing systems often integrate large-scale language models, if at all, in an ad-hoc way that does not control how prompts are constructed from internal data structures, thereby causing unstable inference behavior, increased token usage, and degraded efficiency in processor and network resource utilization.

Furthermore, known systems do not systematically combine multiple heterogeneous engines on the server side-such as dialog engines, natural language processing pipelines, disease information repositories, emotion analysis engines, and generative AI models-into a coordinated control flow. As a result, the server cannot reliably transform unstructured dialog streams into high-quality structured case information that optimizes triage accuracy, and cannot provide machine-generated rationale and uncertainty information in a form that can be consumed by downstream clinical workflows. This leads to technical problems in the computing system itself, including: (i) redundant and inconsistent data representations across modules, (ii) inefficient use of processing cycles and external model calls, (iii) lack of controllable prompt templates, and (iv) difficulty in scaling the system while keeping latency and model-call cost under control.

In addition, existing systems that attempt to use emotion analysis typically treat emotional scores as ancillary metadata, without technically integrating these scores into the data structures used for candidate disease pickup or into the prompts sent to generative models.

This fragmented design prevents the processor from jointly optimizing symptom and emotion features when computing similarity with disease profiles, and prevents the system from automatically adjusting prompt content to emphasize emotionally critical aspects of a case.

Consequently, there is a need for a computer-implemented technique in which the server-side processor orchestrates dialog processing, multi-stage natural language processing, emotion analysis, disease profile comparison, and generative AI model prompting in a unified pipeline, such that structured data quality, candidate disease pickup accuracy, and the stability and efficiency of generative AI inference are improved as a matter of computer technology rather than human post-processing.

The specific processing by the specific processing unit 290 of the data processing device 12 in Application Example 2 is realized by the following means.

The present invention provides a server comprising a processor and a memory storing instructions which, when executed by the processor, cause the processor to receive, via a user terminal, input information including symptom information and emotional information, to send the input information and dialog history to a dialog engine and obtain a primary interview result, to execute a natural language processing pipeline on the primary interview result to extract symptom terms, duration information, severity information, and context information and to store them as structured data in the memory, to execute an emotion analysis engine on the input information and the primary interview result to compute an emotional state and to store the emotional state as quantified emotion features, to compare the structured data and the emotional state with disease profile information including epidemic disease information stored in a disease information repository to generate candidate disease pickup data, and to construct, based on the structured data, the emotional state, and the candidate disease pickup data, a machine-readable prompt sentence that conforms to a predetermined template and that is transmitted to a generative AI model as an input sequence.

This enables the server to transform unstructured dialog streams into normalized structured case representations optimized for subsequent generative inference, to control the behavior of the generative AI model through explicit prompt templates that embed internal data structures, and to thereby improve the technical performance of the computing system in terms of data quality, inference stability, processing efficiency, and accuracy of candidate disease pickup.

The present invention further provides that the server is configured to receive, from the generative AI model, an analysis result including a list of candidate diseases, explanatory reasoning, and an indication of whether medical consultation is recommended, and to automatically generate, from the analysis result, distinct machine-generated outputs for different consumers, including a patient-facing notification message and a clinician-facing support record. The clinician-facing support record integrates the structured data, the emotional state, the candidate disease pickup data, and the analysis result into a unified data object stored in the memory, and the server is configured to present this data object via a network interface to a clinical terminal. This enables the computing system to provide machine-generated explanations and uncertainty indications in a structured format that can be directly consumed by downstream applications, thereby reducing manual data reconciliation and improving the throughput and reliability of server-side decision-support operations.

The present invention also provides that the server is configured to generate, during or after the primary interview, additional prompt sentences instructing the generative AI model to identify missing information and to generate follow-up questions, to transmit the follow-up questions to the terminal, to receive and re-analyze user responses, and to update the structured data and the candidate disease pickup data stored in the memory. The server is further configured to update a prompt template repository by providing, to the generative AI model, meta-prompts that request improvements to the format or content of the prompt sentences based on accumulated case information and analysis results. This enables adaptive optimization of prompt design within the computing system itself, improving the efficiency of token usage, the consistency of generative outputs, and the overall robustness and scalability of the server-side architecture.

The term “system” refers to a combination of hardware and software components, including at least one processor, memory, communication interfaces, and executable programs, that cooperatively perform the claimed processing.

The term “processor” refers to a hardware processing unit, such as a central processing unit or a dedicated computing core, that executes instructions stored in a memory to perform logical operations, data processing, and control of other components.

The term “terminal” refers to an information processing device, such as a smartphone, tablet, or personal computer, that provides a user interface for receiving input information from a user and for displaying messages or questions sent from a server.

The term “user” refers to a human operator, such as a patient or visitor, who interacts with the terminal by providing input information and viewing outputs.

The term “input information” refers to data provided by the user via the terminal, including natural language text or structured selections that describe symptom information, emotional information, or other health-related information.

The term “symptom information” refers to data that describes physical or psychological conditions experienced by the user, such as pain, cough, fever, insomnia, or similar health-related manifestations.

The term “emotional information” refers to data that expresses or implies a psychological state of the user, such as anxiety, fear, stress, sadness, or similar emotional conditions.

The term “dialog history” refers to a sequence of exchanges between the user and a dialog program or chatbot, including user utterances, system questions, and associated timestamps or metadata.

The term “dialog program” refers to a software component or service that conducts interactive question-and-answer communication with the user using natural language processing, and that outputs interpreted intents, extracted entities, or follow-up questions.

The term “primary interview” refers to an initial sequence of dialog interactions and analyses that collect basic symptom information and contextual information from the user to form a preliminary assessment.

The term “natural language analysis” refers to computational processing applied to human language text, including at least one of tokenization, part-of-speech tagging, syntactic parsing, intent classification, entity extraction, or semantic interpretation.

The term “natural language processing algorithm” refers to a software procedure or model that performs natural language analysis on text data to extract structured information such as terms, attributes, relationships, or labels.

The term “symptom term” refers to a word or phrase detected by the natural language processing algorithm that represents a specific symptom, such as “cough”, “headache”, or “fever”.

The term “duration information” refers to data that indicates a length of time associated with a symptom, such as “for three days” or “for two weeks”.

The term “severity information” refers to data that indicates an intensity or magnitude of a symptom, such as “mild”, “moderate”, or “severe”.

The term “context information” refers to data that provides situational or temporal context for a symptom, such as “at night”, “during exercise”, or “after meals”.

The term “structured data” refers to data that is organized into predefined fields or data structures, such as records, lists, or key-value pairs, enabling algorithmic processing and storage in a database.

The term “emotion analysis algorithm” refers to a software procedure or model that analyzes text, audio, or other input signals to estimate an emotional state of the user, including categories and intensities.

The term “emotional state” refers to an estimated psychological condition of the user represented in one or more emotion categories, such as anxiety or fear, and associated strength values.

The term “emotion category” refers to a label that classifies an emotional state, such as “anxiety”, “sadness”, “anger”, “fear”, or “neutral”.

The term “emotion intensity” refers to a numerical value or scale that quantifies a degree of an emotion category, such as a probability, a score, or a level.

The term “case information” refers to a collection of data associated with a single triage or diagnostic session, including structured symptom data, emotional state data, and related metadata.

The term “disease information storage unit” refers to a storage resource, such as a database or knowledge base, that retains disease profile information including symptom patterns and epidemiological attributes.

The term “disease profile information” refers to data describing characteristics of a disease, including typical symptom sets, associated durations, severities, and prevalence information.

The term “epidemic disease information” refers to disease profile information that further includes data about currently prevalent or outbreak-related diseases in one or more regions.

The term “symptom pattern” refers to a combination of symptoms, durations, severities, and contexts associated with a disease or with a user case, used for similarity comparison.

The term “candidate disease” refers to a disease identified as possibly relevant to the user's condition based on similarity between case information and disease profile information.

The term “candidate disease pickup data” refers to data indicating candidate diseases selected by an algorithm, together with scores or evidence representing similarity or likelihood.

The term “generative AI model” refers to a machine learning model, such as a large-scale language model, that generates text or other data in response to prompts, based on patterns learned from training data.

The term “prompt sentence” refers to a text string or sequence of tokens provided as input to the generative AI model, which specifies instructions, context, or questions that guide the model's output.

The term “predetermined template” refers to a predefined format or schema for constructing a prompt sentence, specifying positions and order of case elements to be embedded in the prompt sentence.

The term “analysis result” refers to data produced by the generative AI model in response to a prompt sentence, including at least a list of candidate diseases, explanatory reasoning, or recommended actions.

The term “recommended action” refers to guidance suggested by the generative AI model for the user or medical professional, such as visiting a medical institution, monitoring symptoms, or seeking further evaluation.

The term “patient-facing notification message” refers to a text message generated for presentation to the user, providing understandable information and recommendations based on the analysis result.

The term “medical professional” refers to a person qualified to perform medical diagnosis or treatment, such as a physician, nurse, or other healthcare provider.

The term “clinician-facing support record” refers to a structured data object that aggregates case information, candidate disease pickup data, emotional state data, and analysis results for use by a medical professional.

The term “primary interview result” refers to output data from the dialog program that summarizes the initial interaction with the user, including interpreted intents, extracted entities, and question-and-answer content.

The term “follow-up question” refers to an additional question generated during or after the primary interview to obtain missing or clarifying information regarding the user's condition.

The term “prompt template repository” refers to a storage entity that maintains one or more templates used to construct prompt sentences for the generative AI model.

The term “meta-prompt” refers to a prompt sentence directed to the generative AI model for the purpose of improving or generating prompt templates, rather than for direct clinical analysis.

The term “pickup result” refers to the output of a selection process that identifies candidate diseases based on similarity or rule criteria applied to case information and disease profile information.

The term “network interface” refers to a hardware and software combination that enables the server to communicate with external devices or services over a communication network.

In one embodiment, a server, a terminal, and a user cooperate to implement the claimed system. The server includes at least one processor, a main memory, a non-volatile storage device, and a network interface. The processor is, for example, a general-purpose central processing unit (CPU) or a combination of a CPU and a graphics processing unit (GPU). The memory stores executable programs including a dialog program, a natural language processing module, an emotion analysis module, a disease profile comparison module, a prompt generation module, and a generative AI interface module. The storage device stores log data, case information, disease profile information, and prompt templates.

The network interface connects the server to one or more terminals via a communication network.

The terminal is, for example, a portable information processing apparatus such as a smartphone or tablet. The terminal includes an input device such as a touch panel, one or more sensors such as a microphone and a camera, a display device, a local storage, and a communication module. The terminal executes an application program that presents a chat-style user interface, transmits user input to the server, and displays messages and notifications received from the server.

The user operates the terminal and inputs symptom information and emotional information in natural language text or by selecting items from a list. The user may, for example, enter a sentence such as “Recently I have a bad cough and a fever, and I feel anxious” or “Recently my headache gets worse at night and I cannot sleep well.” The terminal packages the input text and associated metadata such as a user identifier, a timestamp, and a language code, and transmits them to the server.

The server uses a dialog program to conduct a primary interview. The dialog program can be realized as a remote conversation engine service accessed via an application programming interface, or as a local dialog management module. The server passes the user input and dialog context to the dialog program. The dialog program applies a natural language understanding pipeline including tokenization, part-of-speech tagging, intent classification, and entity extraction to the user's utterances. The dialog program returns interpreted intents, extracted entities (for example, “cough”, “fever”, “for three days”), and follow-up questions.

The server stores the dialog turns as dialog history in a structured format within the storage device.

The server uses a natural language processing module to convert the primary interview result into structured data. The server segments dialog texts into sentences, identifies symptom terms, duration expressions, severity expressions, and context expressions, and assigns them to specific fields of a case information data structure. In one embodiment, the server represents each symptom as a record containing fields such as symptom_name, duration, severity_score, context_flags, and extraction_confidence. The server aggregates these records into a symptom list associated with a case identifier. The server normalizes synonym expressions (for example, “high temperature” into “fever”) by using a synonym dictionary and a mapping table. This structured representation allows downstream modules to perform algorithmic comparison and scoring rather than text-only processing.

The server uses an emotion analysis module to evaluate the emotional state of the user. The server selects, as input to the module, one or more user utterances that contain emotional expressions or that are representative of the entire dialog. The emotion analysis module applies a feature extraction process that converts text tokens into numeric feature vectors using, for example, word embeddings or sentence embeddings. The module then passes the feature vectors through a classifier model that has been trained to output emotion categories and intensities. In one embodiment, the classifier is a neural network having an embedding layer, one or more bidirectional recurrent layers or transformer layers, and a dense output layer that produces scores for emotion categories such as anxiety, fear, sadness, and neutral.

The server interprets the scores as emotion intensities and stores an emotional state record including emotion_category, intensity_value, and confidence_value in association with the case.

The server uses a disease information storage unit that retains disease profile information.

The disease information storage unit may be implemented as a relational database or a key-value store. Each disease profile includes a disease identifier, a set of canonical symptoms, typical durations and severities, context conditions, and whether the disease is currently listed as epidemic in one or more regions. The server pre-loads or periodically updates these disease profiles from external data sources, such as health organization feeds, and stores them in a normalized format. For example, a disease profile may include fields such as canonical_symptom_vector, duration_range_vector, severity_pattern, and prevalence_weight.

The server uses a disease profile comparison module to pick up candidate diseases based on similarity between the structured case information and the disease profiles. The module constructs a feature vector for the user's case, including symptom presence indicators, normalized duration values, normalized severity scores, and context flags. The module also uses the emotional state as an auxiliary feature, for example as an additional dimension that may influence ranking for stress-related or anxiety-related conditions. The module computes similarity scores between the case feature vector and each disease profile vector using one or more metrics such as cosine similarity, weighted dot product, or rule-based scoring. The module outputs candidate disease pickup data as a list of disease identifiers with corresponding similarity scores and evidence items. The server stores the candidate disease list in the storage device.

The server uses a prompt generation module to construct prompt sentences for a generative AI model. The server reads the structured symptom data, the emotional state data, and the candidate disease pickup data, and fills a predetermined template with these elements. The server, for example, formats a prompt sentence as follows:

“You are a medical triage assistant.

### User's Symptoms:

Cough for 3 days
Fever for 3 days (about 38.5 degrees)
Fatigue

### Emotion Analysis:

Primary emotion: anxiety (score 0.85)

### External Disease Data:

Influenza: currently prevalent, high symptom match
COVID-19: currently prevalent, moderate symptom match

### Task:

1) Evaluate the possibility of influenza, COVID-19, or other conditions (not a final diagnosis).
2) State whether the user should be advised to visit a medical institution.
3) Generate a short notification sentence suitable for display on a smartphone.”

The server can also construct a prompt sentence for follow-up question generation, for example:

“User description: ‘Recently I have a bad cough and a fever for 3 days.’

### Task:

1) List the most important 3 follow-up questions a doctor would ask to clarify severity and risk factors.

Output as a bullet list.”

The server transmits these prompt sentences to the generative AI model interface module. In one embodiment, the generative AI model is a transformer-based language model deployed as a network-accessible inference service. The model is pre-trained on large text corpora and optionally fine-tuned on medical dialog data. The model uses a stack of self-attention layers with multi-head attention, feed-forward networks, and layer normalization. During inference, the model receives the prompt sentence as a token sequence, computes attention over the token sequence using learned weights, and generates output tokens autoregressively based on learned conditional probability distributions. The server specifies generation parameters such as maximum token length, temperature, and top-k sampling settings in order to control variability and coherence of the output.

The server receives the output text from the generative AI model and parses it according to the expected format. For example, if the prompt instructs the model to output a list of candidate conditions and a recommendation, the server splits the output into sections and identifies disease names, explanations, and recommendation statements. The server stores this analysis result in the storage device as part of the case information.

The server generates distinct outputs for the user and for a medical professional. For the user, the server constructs a notification message based on the analysis result, for example:

“There is a possibility of influenza based on your symptoms of cough and fever for 3 days. We recommend that you visit a medical institution soon.”

The server transmits this message to the terminal, which displays the message on the screen in a user-friendly format. For the medical professional, the server constructs a clinician-facing support record that aggregates the structured symptom list, the emotional state, the candidate disease pickup data, and key elements of the generative AI model's reasoning. The server provides this record through a web-based interface or a clinical application, enabling the medical professional to quickly review computationally derived suggestions and to incorporate them into a final diagnosis.

The server also uses the generative AI model for adaptive optimization of prompt templates.

The server prepares meta-prompts that request improved prompt designs based on cases and outcomes, for example:

“We are building a triage system. User texts contain both medical symptoms and emotional expressions.

Describe an optimal prompt sentence format to send to a generative AI model so that it:
1) extracts symptoms and emotions,
2) picks up possible diseases,
3) generates a short notification for the user.

Output your suggestion as a template with placeholders.”

The server transmits such meta-prompts to the generative AI model and receives proposed template improvements. The server validates and stores improved templates in a prompt template repository. By iteratively updating the templates based on accumulated dialog data and performance metrics, the server reduces unnecessary tokens, improves the stability of generated outputs, and increases model reusability across cases. This adaptive prompt optimization represents a technical improvement in how the server controls a large language model, rather than merely automating human drafting of questions.

The server can implement alternative embodiments for the emotion analysis module. In a text-only configuration, the server uses a recurrent neural network classifier that converts word embeddings into hidden states and applies a softmax layer over emotion categories. In a multimodal configuration, the terminal acquires facial images or audio signals from the user under user consent, and transmits features such as facial landmark coordinates or spectral audio features to the server. The server fuses these features with text embeddings using a multimodal neural network, for example by concatenating features and applying dense layers with non-linear activation functions. This configuration allows the server to detect subtle emotional cues that are difficult to capture in text alone, which in turn affects ranking of candidate diseases or priority levels of triage recommendations.

The server uses specific data structures and control flows that yield technical effects beyond simple automation. The server normalizes diverse inputs into structured feature vectors that are directly comparable with disease profile vectors, thereby reducing noise and redundancy.

The disease profile comparison module compresses high-dimensional symptom and context data into scalar similarity scores using optimized linear algebra operations. As a result, the server reduces the number of candidate diseases that must be included in prompt sentences, thus lowering token counts and network traffic between the server and the generative AI service. The reduced token counts lead to lower latency and decreased computational load on the generative AI model, which is a direct technical improvement in processing efficiency.

The server's use of tailored prompt templates that embed structured data, rather than raw text transcripts, improves the precision of model outputs and reduces variance in responses.

Because the generative AI model receives consistently formatted prompts with explicit lists of symptoms, durations, and candidate diseases, the model can focus its attention mechanism on medically relevant tokens, which leads to more stable and predictable outputs. The server's systematic combination of rule-based similarity scoring with generative reasoning thereby reduces the error rate of candidate disease pickup compared to systems that rely solely on static rules or solely on free-form language model outputs.

The server, by generating follow-up questions via the generative AI model based on missing fields in structured data, implements a non-conventional control loop. The server compares case data against a schema that specifies required and optional fields, identifies which values are missing or ambiguous, and constructs prompt sentences that instruct the generative AI model to produce targeted questions about those fields. The server then uses user responses to complete or refine the feature vectors. This iterative refinement of structured data leads to improved similarity calculations and reduces misclassification due to incomplete information.

The causality is that more complete and precisely structured inputs lead to more accurate disease profile comparisons and generative outputs, thereby enhancing technical performance of the system.

The terminal participates in technical processing by encoding and decoding data in specific formats. The terminal converts user text input into unicode strings, attaches metadata identifiers, and serializes them into a compact representation for transmission, such as a compressed JSON-like format. The terminal may also apply local input validation and lightweight preprocessing, such as splitting multiple sentences or removing unsupported characters, which reduces server-side preprocessing overhead and improves robustness against malformed inputs. The terminal receives structured messages from the server and renders them using a graphical user interface, which may highlight symptom terms or risk levels. This rendering assists the user in quickly understanding system outputs and reduces the likelihood of misinterpretation.

The user benefits from the improved speed and reliability of the system's responses. Because the server has optimized prompt construction and candidate disease filtering, the server can obtain high-quality generative AI outputs in fewer inference calls and with shorter prompts.

This leads to faster round-trip times between user input and system feedback, which is particularly important in time-sensitive triage situations. Moreover, the integration of emotional state information into both the candidate disease ranking and the prompt content allows the server to prioritize emotionally critical cases and to generate more empathetic and context-aware messages.

In alternative embodiments, the server can deploy the generative AI model locally, for example on a GPU-equipped appliance located within a healthcare facility. In such cases, the server transfers tokenized prompts to the local model via high-speed interconnects, and obtains outputs without traversing an external network. This configuration further reduces latency and enhances privacy control. The core architecture of structured data generation, disease profile comparison, prompt sentence construction, and generative inference remains the same, so the technical advantages of improved efficiency, accuracy, and stability are preserved.

In summary, the server orchestrates a multi-stage processing pipeline in which raw user text is progressively transformed into structured feature vectors, similarity scores, and optimized prompt sentences that are specifically designed to control a generative AI model. This pipeline results in improved utilization of computing resources, reduced communication overhead, and higher quality of decision-support outputs compared to conventional systems that either rely on fixed rules or employ large language models in an unstructured, ad-hoc manner. By tightly coupling internal data structures with generative prompting, the system accomplishes a technical improvement in computer-implemented triage and decision support, rather than merely automating human cognitive tasks.

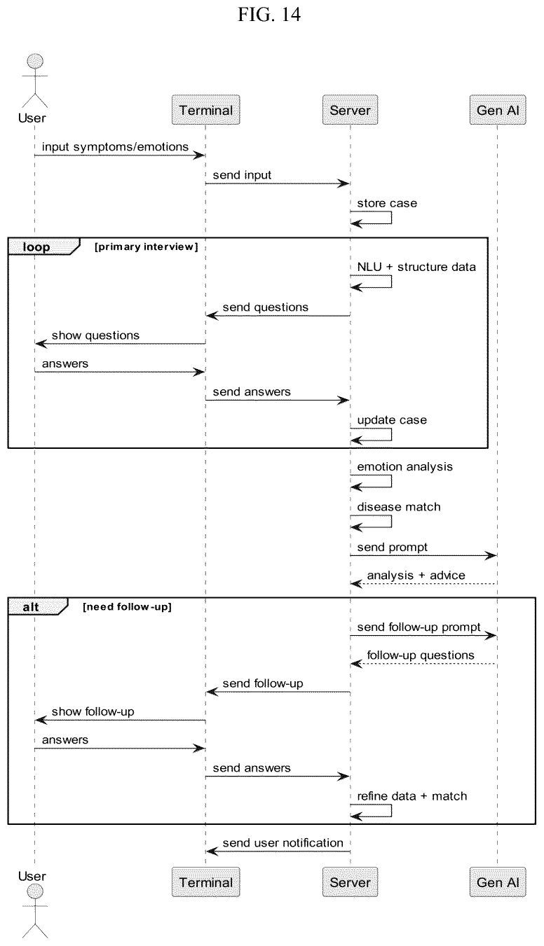

The following describes the processing flow using FIG. 14.

### Step 1:

User operates the terminal to input symptom information and emotional information.

User views a chat-style screen on the terminal and types one or more natural language sentences, for example, “Recently I have a bad cough and a fever, and I feel anxious,” or selects symptoms and emotions from predefined lists.

Input: free-form text and selected items entered on the terminal.

Terminal validates that mandatory fields are filled, converts the text into a unicode string, attaches metadata such as user identifier, timestamp, and language code, and constructs a request object.

Output: a structured request object including the user's raw text, selected items, and metadata, stored temporarily in local memory.

### Step 2:

Terminal sends the user input to the server and waits for a response.

Terminal serializes the request object into a compact representation (for example, a JSON-like structure), optionally compresses it, and transmits it via a secure communication channel to a predefined server endpoint.

Input: the request object containing user text and metadata.

Terminal uses a communication module to open a network connection, write the serialized data to the connection, and handle transmission errors or retries.

Output: a network message delivered to the server and an internal state in the terminal indicating that the case has been opened and is awaiting server processing.

### Step 3:

Server receives the request and stores raw case data.

Server uses a network interface to accept the incoming message, parses the serialized representation, and extracts fields such as user identifier, text, and timestamp.

Input: the network message from the terminal.

Server validates the data, generates a new case identifier, and writes a record to a storage device, including the raw text and metadata as initial case information.

Output: a persistent case record indexed by the case identifier and a parsed representation of the user input stored in memory for further processing.

### Step 4:

Server invokes a dialog program to obtain a primary interview result.

Server sends the user's text and current dialog context to a dialog program and instructs the dialog program to perform natural language understanding and question generation.

Input: parsed user text and existing dialog history (initially empty).

The dialog program tokenizes the text, tags parts of speech, classifies intent, and extracts entities such as symptom names and durations, then generates a reply text and optional follow-up questions.

Output: a primary interview result including detected intents, extracted entities, and a response message, stored in server memory and linked to the case.

### Step 5:

Server returns dialog questions and messages to the terminal.

Server reads the primary interview result and constructs a response that includes the dialog program's reply and any follow-up questions for the user.

Input: the primary interview result with response text and follow-up questions.

Server encodes this response into a serialized representation and sends it back over the network.

Output: a response message delivered to the terminal containing one or more questions and instructions for continuing the dialog.

### Step 6:

Terminal presents follow-up questions and collects additional user responses.

Terminal receives the server response, decodes it, and displays the dialog program's message and questions on the screen.

Input: the response message including follow-up questions.

User reads the questions and enters additional information, for example, “I have had a fever for 3 days.”

Terminal appends this new text to the dialog history, constructs an updated request object including the case identifier and the new user message, and sends it to the server.

Output: a new network message containing the additional user response and updated dialog history.

### Step 7:

Server aggregates dialog history and repeats primary interview as needed.

Server receives new user responses, appends them to the existing dialog history associated with the case, and passes the updated dialog history to the dialog program.

Input: the case identifier and new user message from the terminal.

The dialog program processes the dialog history, updates extracted entities and intents, and determines whether additional questions are required; if so, it generates further questions.

Output: an updated primary interview result with refined entities and possibly new questions, stored in memory and sent back to the terminal until sufficient information is collected.

### Step 8:

Server transforms the dialog into structured symptom data.

Server concatenates the user's messages from the dialog history and applies a natural language processing algorithm to extract symptom terms, durations, severities, and contexts.

Input: the complete dialog history and the latest primary interview result.

Server performs tokenization, pattern matching, and entity normalization, maps synonyms to canonical symptom names, and constructs structured records such as symptom_name, duration, severity_score, and context_flags.

Output: a structured symptom list stored in a case information structure and saved in the storage device.

### Step 9:

Server computes an emotional state from the user's text.

Server selects one or more representative user utterances and passes them to an emotion analysis algorithm.

Input: selected user sentences from the dialog history.

The emotion analysis algorithm converts words into numeric feature vectors, passes them through a trained classifier network that outputs scores for emotion categories, and the server interprets these scores as emotion_category and emotion_intensity values.

Output: an emotional state record including categories and intensities, stored as part of the case information.

### Step 10:

Server constructs a feature vector for disease comparison.

Server combines the structured symptom data and emotional state data into a numerical feature representation suitable for similarity computation.

Input: the symptom list, duration values, severity scores, context flags, and emotional state record.

Server encodes symptom presence as binary or weighted features, normalizes durations and severities into numeric scales, adds emotional intensity scores as auxiliary dimensions, and assembles these into a fixed-length feature vector.

Output: a case feature vector representing the user's condition and emotional state, stored in memory for comparison with disease profiles.

### Step 11:

Server compares the case feature vector with disease profiles.

Server retrieves disease profile vectors from the disease information storage unit and computes similarity scores between the case feature vector and each disease vector.

Input: the case feature vector and a set of disease profile vectors.

Server uses mathematical operations such as dot products or cosine similarity, and optionally rule-based weighting, to calculate similarity for each disease and sorts diseases by score.

Output: candidate disease pickup data listing diseases, similarity scores, and evidence features, stored in the case information as a ranked list.

### Step 12:

Server builds a prompt sentence for a generative AI model.

Server reads the structured symptom data, emotional state, and candidate disease pickup data and inserts them into a predetermined text template.

Input: the structured case information and ranked candidate disease list.

Server constructs a structured narrative prompt sentence, for example:

“You are a medical triage assistant.

### User's Symptoms:

Cough for 3 days
Fever for 3 days (about 38.5 degrees)
Fatigue

### Emotion Analysis:

Primary emotion: anxiety (score 0.85)

### External Disease Data:

Influenza: currently prevalent, high symptom match
COVID-19: currently prevalent, moderate symptom match

### Task:

1) Evaluate the possibility of influenza, COVID-19, or other conditions (not a final diagnosis).
2) State whether the user should be advised to visit a medical institution.
3) Generate a short notification sentence suitable for display on a smartphone.”

Server stores this prompt sentence in memory and prepares it for transmission.

Output: a complete prompt sentence text that encodes case information in a format suitable for generative inference.

### Step 13:

Server sends the prompt sentence to the generative AI model and receives an analysis result.

Server transmits the prompt sentence to a generative AI model interface, which forwards the tokenized text to a transformer-based language model.

Input: the prompt sentence describing symptoms, emotions, and candidate diseases.

The generative AI model processes the tokens through multiple attention layers and generates output text that may include candidate conditions, reasoning, and recommendations; the server receives this text and parses it according to expected sections.

Output: an analysis result containing, for example, a list of candidate diseases, explanatory text, and a recommendation about visiting a medical institution, stored as structured fields in the case information.

### Step 14:

Server generates follow-up questions using the generative AI model if information is missing.

Server inspects the structured case data to identify missing or low-confidence fields, such as unknown onset time or unclear severity, and constructs an additional prompt sentence to request targeted questions from the generative AI model.

Input: the case schema, current structured data, and a list of missing or ambiguous attributes.

Server builds a prompt, for example:

“User description: ‘Recently I have a bad cough and a fever for 3 days.’

### Task:

1) List the most important 3 follow-up questions a doctor would ask to clarify severity and risk factors.

Output as a bullet list.”

The generative AI model outputs follow-up questions, and the server parses them into individual question strings.

Output: a set of follow-up question texts stored in memory and ready to be sent to the terminal.

### Step 15:

Terminal presents follow-up questions and sends new user responses to the server.

Terminal receives the follow-up questions from the server and displays them sequentially in the chat interface.

Input: the follow-up question texts from the server.

User reads each question, enters an answer in natural language, and the terminal packages these answers with the case identifier into a new message and transmits it back to the server.

Output: updated user responses delivered to the server, enabling refinement of structured symptom data.

### Step 16:

Server updates structured data and candidate diseases based on follow-up responses.

Server receives the new user answers, appends them to the dialog history, and re-applies the natural language processing and emotion analysis steps as needed.

Input: additional user responses and the existing case information.

Server extracts new or refined symptom terms, durations, and severities, updates the feature vector, recomputes similarity with disease profiles, and updates the candidate disease pickup data.

Output: an updated case feature vector and a revised ranked list of candidate diseases with improved accuracy.

### Step 17:

Server produces a patient-facing notification message.

Server reads the final analysis result from the generative AI model together with the updated candidate disease list and constructs a concise message for the user.

Input: the analysis result and refined candidate disease pickup data.

Server selects key findings, such as high likelihood of a specific disease and a recommendation to visit a medical institution, and generates a natural language notification, for example, “There is a possibility of influenza based on your symptoms. We recommend that you visit a medical institution soon.”

Output: a patient-facing notification message stored in memory and formatted for transmission to the terminal.

### Step 18:

Server generates a clinician-facing support record.

Server consolidates the structured symptom data, emotional state, candidate disease pickup data, and key parts of the generative AI model's reasoning into a unified record.

Input: all structured case components including features, scores, and explanations.

Server organizes this information into fields that can be displayed in a clinical interface, such as summary of symptoms, emotion profile, ranked candidate diseases, and rationale text, and writes the record to persistent storage.

Output: a clinician-facing support record that can be retrieved and viewed by a medical professional.

### Step 19:

Server sends the patient-facing notification to the terminal.

Server uses the network interface to transmit the notification message to the terminal over a secure channel.

Input: the patient-facing notification message and the user's terminal identifier.

Server encodes the message in a format recognized by the terminal application and signals that a new message is available.

Output: a delivered notification that the terminal can present to the user.

### Step 20:

Terminal displays the notification and optionally forwards the clinician record to a professional terminal.

Terminal receives the notification message and renders it on the display in a manner that is easy for the user to read.

Input: the notification message from the server.

Terminal may additionally transmit a reference to the clinician-facing support record to a separate professional terminal or system, enabling a medical professional to access the detailed case data.

Output: visual presentation of the notification to the user and optional network messages linking the clinician to the support record.

### Step 21:

Server updates and optimizes prompt templates using meta-prompts.

Server periodically analyzes performance metrics, such as accuracy of candidate disease pickup and response latency, and selects representative cases to refine prompt templates.

Input: historical case data, analysis results, and performance statistics.

Server constructs meta-prompts that describe shortcomings or desired improvements in prompt design and sends them to the generative AI model; the model returns revised template suggestions, which the server evaluates and stores in a prompt template repository for use in future prompt generation.

Output: updated prompt templates that reduce token counts, improve stability of outputs, and enhance the efficiency of future generative AI calls.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

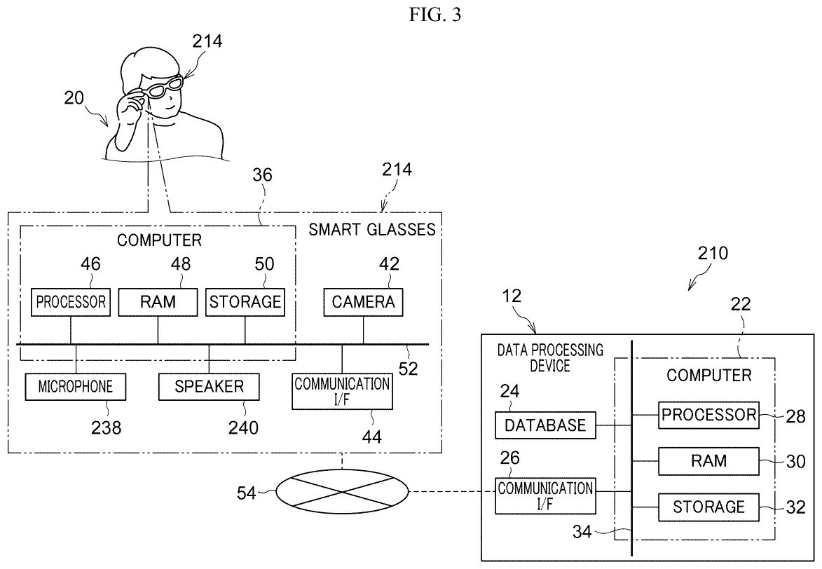

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

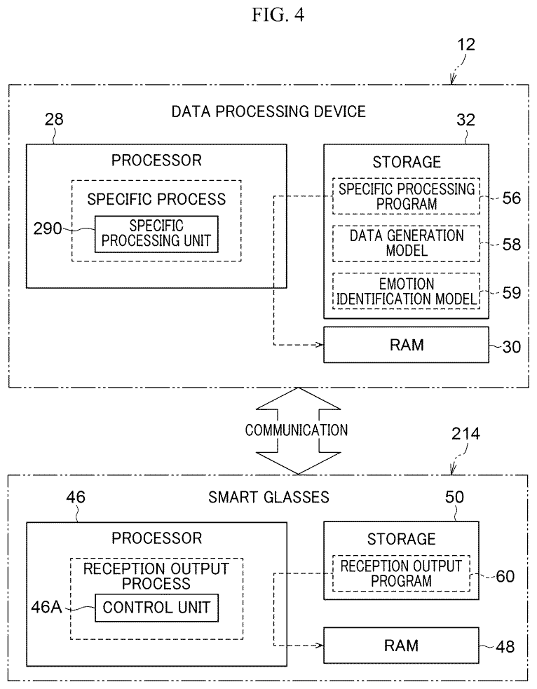

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

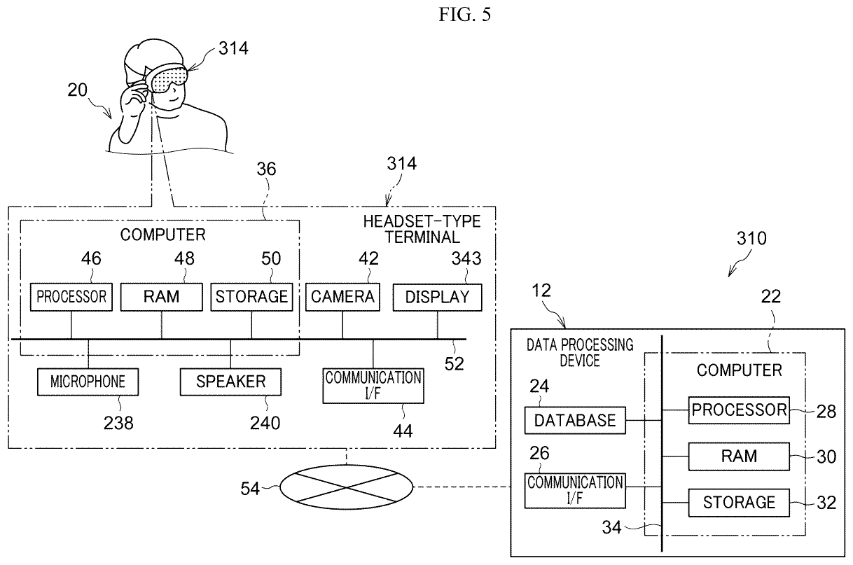

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

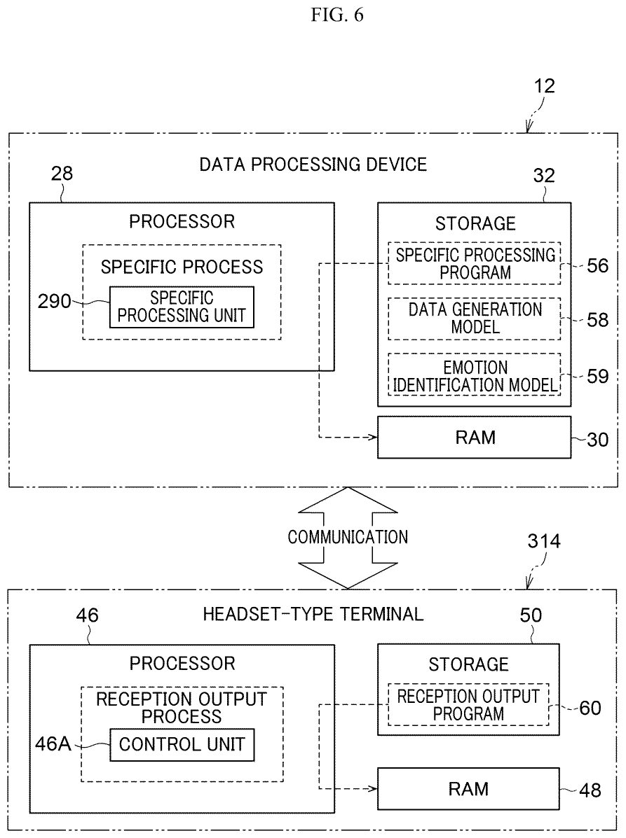

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314.

In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

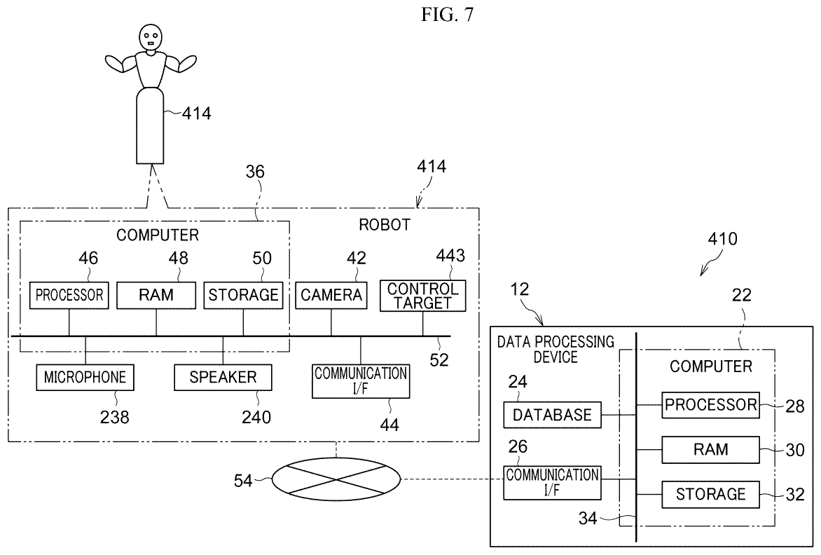

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

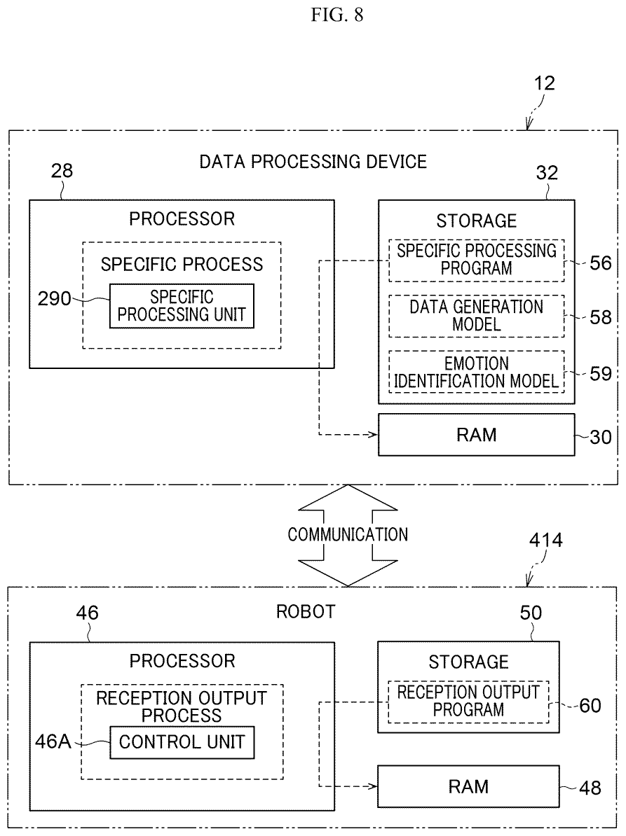

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

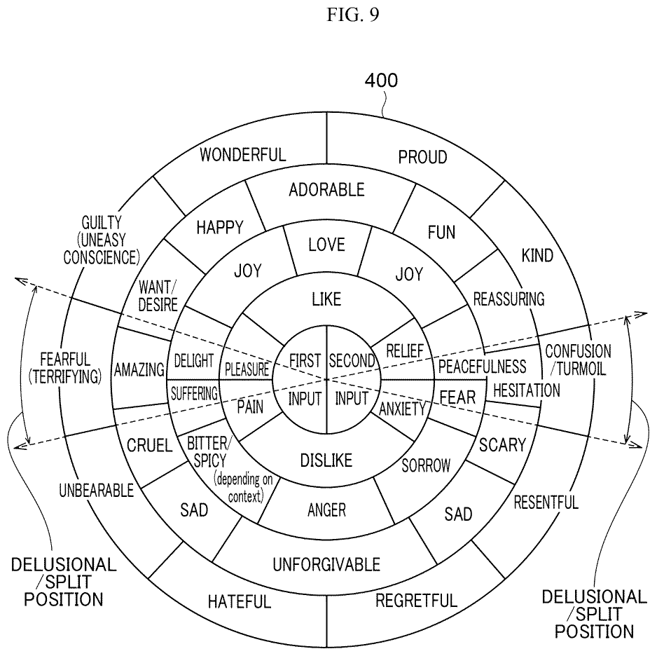

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

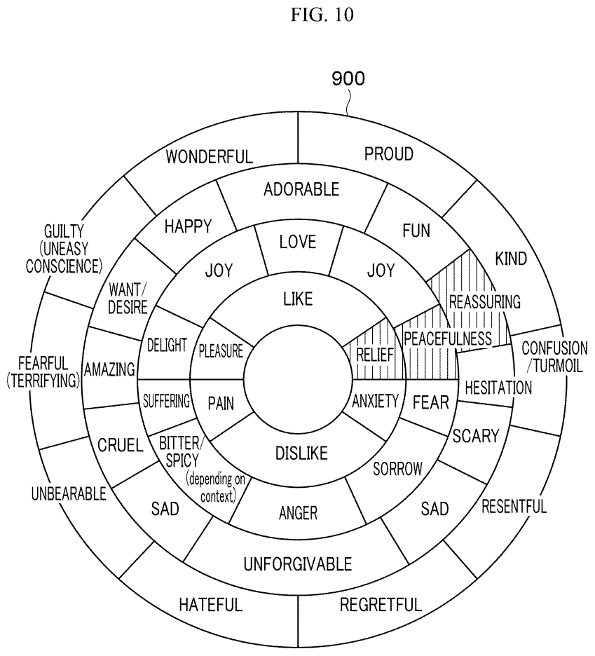

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, a storage device, and a plurality of information processing apparatuses,
wherein the processor is configured to receive symptom information and selection information expressed in natural language from a user via a user-side information processing apparatus, and store the symptom information and the selection information as dialogue history on a per-user basis in the storage device,
wherein the processor is configured to generate a prompt sentence including the dialogue history as input information to a generative AI model that performs natural language processing, and to input the prompt sentence to the generative AI model so as to instruct the generative AI model to execute an analysis process on the input information,
wherein the processor is configured to generate, on the basis of an analysis result output from the generative AI model, one or more additional question sentences for obtaining additional information required for diagnosis from the user, and to transmit the one or more additional question sentences to the user-side information processing apparatus so that the one or more additional question sentences are presented to the user,
wherein the processor is configured to acquire, from the user-side information processing apparatus, response content from the user to the one or more additional question sentences, to sequentially add the response content to the dialogue history to update the dialogue history, and to repeatedly execute the analysis process and generation of the one or more additional question sentences until necessary information is collected by generating and transmitting, for the updated dialogue history, another prompt sentence to be input to the generative AI model, wherein the processor is configured to generate a prompt sentence including structuring instructions for inputting the dialogue history collected by the repeated execution to the generative AI model, to input the prompt sentence to the generative AI model so as to instruct the generative AI model to execute a structuring process on symptom information contained in the dialogue history, and to acquire structured symptom information output from the generative AI model,
wherein the processor is configured to compare the structured symptom information with disease information stored in the storage device, to calculate, for a plurality of disease candidates, a relevance value for each of the plurality of disease candidates with respect to the structured symptom information, and to extract a disease candidate list including the plurality of disease candidates and the relevance values,
wherein the processor is configured to generate medical information including the structured symptom information and the disease candidate list, and to provide the medical information to a medical-worker-side information processing apparatus,
and wherein the processor is configured to evaluate an emotional state on the basis of input information from a patient by using an emotion analysis engine, and to provide, to the medical-worker-side information processing apparatus, a result of evaluation of the emotional state by the emotion analysis engine in association with the medical information.

### (Supplementary 2)

The system according to supplementary 1,
wherein the processor is configured to input, to the generative AI model, a prompt sentence including condition information for instructing improvement of analysis accuracy and comprehensiveness of information extraction when the natural language processing is performed on the basis of the input information and the dialogue history from the user.

### (Supplementary 3)

The system according to supplementary 1,
wherein the processor is configured to input, to the generative AI model, a prompt sentence including condition information for instructing improvement of consistency and
explainability of a final diagnosis when the final diagnosis by a medical worker is performed with reference to an analysis result by the generative AI model, the disease candidate list, and the result of evaluation of the emotional state by the emotion analysis engine, and to cause the generative AI model to generate summary information and explanation information serving as reference for the final diagnosis, and provide the summary information and the explanation information to the medical-worker-side information processing apparatus.

### Application Example 1

### (Supplementary 1)

A system comprising a processor,
wherein the processor is configured to
acquire input information from a user via a user terminal as audio data or character data, convert the audio data into text data by using a speech recognition function,
generate communication data by associating the converted text data with mode information and identification information, and transmit the communication data to a server via a communication path,
obtain the input information from the communication data on the server side and analyze an intention and elements contained in the input information by using natural language processing resources,
determine, based on an analysis result, a processing mode relating to at least one of symptom information in a healthcare field and product information or service information in a commercial field, and acquire, from an information storage device, rule information relating to the symptom information or information relating to the product information or service information in accordance with the processing mode,
generate a prompt sentence to be input to a generative AI model based on the analysis result and the acquired rule information or the acquired product information or service information, input the prompt sentence into the generative AI model, and cause the generative AI model to generate a response sentence,
execute post-processing on the response sentence by performing at least one of safety determination and content formatting, and structure the response sentence as answer information including, in the healthcare field, indicator information indicating a possibility of an epidemic disease and support information for a final diagnosis by a medical specialist, and including, in the commercial field, usage information or inquiry response information, convert the answer information into an output format for presentation to the user by using at least one of a character display function and a speech synthesis function, and transmit the answer information in the output format to the user terminal,
accumulate history information relating to the input information and the response sentence, generate an additional question for the user based on the history information, and present the additional question to the user so as to perform multi-turn dialogue processing,
aggregate symptom information obtained from a plurality of users and analyze a temporal transition and a regional distribution of the symptom information in order to detect a sign of occurrence of an epidemic disease,
evaluate an emotional state of a patient based on the input information by using an emotion analysis function and reflect an evaluation result of the emotional state in the answer information and in information provided to the medical specialist, and
provide, to the medical specialist, at least one of an analysis result generated by the generative AI model, a detection result of the sign of occurrence of the epidemic disease, and the evaluation result of the emotional state as information for performing the final diagnosis.

### (Supplementary 2)

The system according to supplementary 1,
wherein the processor is configured to
include, in the prompt sentence, at least one of a constraint condition and a style instruction for improving an analysis accuracy of the natural language processing and a response quality of the generative AI model.

### (Supplementary 3)

The system according to supplementary 1,
wherein the processor is configured to
include, in the prompt sentence, an instruction to improve at least one of a diagnosis accuracy and a safety level of the final diagnosis performed by the medical specialist with reference to the analysis result generated by the generative AI model, the detection result of the sign of occurrence of the epidemic disease, and the evaluation result of the emotional state, and to operate the generative AI model in accordance with the instruction.

### Example 2

### (Supplementary 1)

A system comprising a processor,
wherein the processor is configured to
acquire, via a terminal device, input information including symptom information from a user, and execute an interview process in a dialog format to receive the input information, and store the input information in a storage device, preprocess the input information stored in the storage device by using a language processing program having a natural language processing function, and extract symptom-related terms included in the input information, and
read, from the storage device, information groups relating to epidemic diseases including symptom information for each disease, calculate a similarity between the symptom-related terms based on the input information and the symptom information by using the language processing program or a similarity calculation program, and extract candidates for epidemic diseases on the basis of the similarity, and
generate, on the basis of the candidates for epidemic diseases and the input information, a prompt sentence as an analysis request instruction text describing symptom information to be analyzed and the candidates for epidemic diseases, input the prompt sentence into a generative artificial intelligence model, and request detailed analysis by the generative artificial intelligence model, and
acquire an analysis result output from the generative artificial intelligence model, generate medical support information including diagnosis candidates, differential candidates, and additional inquiry items on the basis of the analysis result, the candidates for epidemic diseases, and the input information, and present the medical support information to a medical worker, and
evaluate an emotional state by using an emotion analysis program that performs emotion analysis processing on the basis of the input information of a patient, associate an evaluation result of the emotional state with the medical support information, and present the evaluation result of the emotional state to the medical worker so as to support reflection of the evaluation result of the emotional state in a final diagnosis.

### (Supplementary 2)

The system according to supplementary 1,
wherein the processor is configured to
input, into the generative artificial intelligence model, a prompt sentence for instructing improvement of analysis accuracy and preprocessing conditions when performing analysis by the language processing program based on the input information from the user, and adjust execution conditions of the natural language processing on the basis of an analysis policy or auxiliary information obtained from the generative artificial intelligence model.

### (Supplementary 3)

The system according to supplementary 1,
wherein the processor is configured to
input, into the generative artificial intelligence model, a prompt sentence for instructing improvement of diagnosis accuracy and interview procedure when a final diagnosis by the medical worker is performed on the basis of the analysis result by the generative artificial intelligence model, an extraction result of the candidates for epidemic diseases, and an evaluation result of the emotional state by the emotion analysis program, and present to the medical worker diagnosis support proposals, additional input items, and alert information output from the generative artificial intelligence model.

### Application Example 2

### (Supplementary 1)

A system comprising a processor,
wherein the processor is configured to
receive, via a terminal, input information from a user including symptom information and emotional information,
send the input information and a dialog history with the user to a dialog program, cause the dialog program to perform natural language analysis and question-and-answer processing as a primary interview, and obtain a result of the primary interview,
extract, based on the result of the primary interview, symptom terms, duration information, severity information, and context information by using a natural language processing algorithm, and organize the extracted information as structured data,
evaluate, based on the input information and the result of the primary interview, an emotional state of a patient by using an emotion analysis algorithm, and quantify the emotional state as an emotion category and an emotion intensity,
generate case information including the structured data and the emotional state, obtain disease profile information including epidemic disease information from a disease information storage unit, and compare the case information with the disease profile information to generate basic information for picking up candidate diseases according to similarity of symptom patterns,
generate, based on the case information and the disease profile information, a prompt sentence for instructing a generative AI model to evaluate possibilities of diseases and to generate recommended actions, and input the prompt sentence to the generative AI model,
generate, based on an analysis result obtained from the generative AI model, information for a medical professional including a list of the candidate diseases, an explanatory reason for each candidate disease, and a necessity of visiting a medical institution, and also generate a notification message for the patient,
output, as the information for the medical professional, clinical support information in which the candidate diseases, the structured data, the emotional state, and the analysis result by the generative AI model are integrated, thereby enabling the medical professional to reflect an evaluation result of the emotional state in a final diagnosis,
generate, as the notification message for the patient, a message including consultation recommendation content based on the analysis result by the generative AI model, and send the message to the terminal so that the message is displayed to the user,
generate, during or after the primary interview, a prompt sentence for causing the generative AI model to identify missing information and to generate additional questions, present the additional questions to the user, re-analyze responses from the user, and update the structured data and a pickup result of the candidate diseases, and
update a template of the prompt sentence by providing, to the generative AI model, an instruction for improving a format or content of the prompt sentence based on the case information and the analysis result so as to improve accuracy of natural language processing and pickup of the candidate diseases in subsequent processing.

### (Supplementary 2)

The system according to supplementary 1,
wherein the processor is configured to use, as the prompt sentence for the generative AI model, a prompt sentence in which a case summary including the symptom information of the user, the emotional state, the result of the primary interview, and external disease information is described in a predetermined format, and which instructs the generative AI model to improve analysis accuracy of natural language processing and accuracy of pickup of the candidate diseases.

### (Supplementary 3)

The system according to supplementary 1,
wherein the processor is configured to use, when presenting to the medical professional the analysis result by the generative AI model, the pickup result of the candidate diseases, and an evaluation result of the emotional state by the emotion analysis algorithm for the final diagnosis, a prompt sentence that instructs the generative AI model to generate an explanatory text which clarifies reasoning relationships and uncertainties in the diagnosis.

What is claimed is:

1. A system comprising:
circuitry configured to:
receive, via a communication interface coupled to a packet-switched network, input information expressed in natural language from a first terminal device, and store the input information as dialogue history in a storage device;
generate a first prompt sentence including the dialogue history as input information to a generative neural network model, input the first prompt sentence to the generative neural network model, and acquire an analysis result;
generate, based on the analysis result, one or more additional inquiry sentences for obtaining additional information from a user, and transmit the one or more additional inquiry sentences as a notification data packet to the first terminal device;
acquire response content from the first terminal device, update the dialogue history with the response content, and repeatedly execute the analysis and generation of additional inquiry sentences until a predetermined information collection condition is satisfied;
generate a structuring prompt sentence including the dialogue history, input the structuring prompt sentence to the generative neural network model to execute a structuring process on condition indicator data contained in the dialogue history, and acquire structured condition indicator data;
compare the structured condition indicator data with reference category information stored in the storage device, calculate a relevance value for each of a plurality of candidate categories with respect to the structured condition indicator data, and extract a candidate category list comprising the plurality of candidate categories and the relevance values; and
evaluate an emotional state of a subject based on the input information by using an emotion analysis engine, and transmit the structured condition indicator data, the candidate category list, and a result of the emotional state evaluation to a second terminal device via the communication interface.

2. The system according to claim 1, wherein the circuitry is configured to generate the first prompt sentence including condition information for instructing improvement of analysis accuracy and comprehensiveness of information extraction when the generative neural network model performs the analysis on the input information and the dialogue history.

3. The system according to claim 2, wherein the circuitry is configured to generate a summary prompt sentence including the structured condition indicator data, the candidate category list, and the result of the emotional state evaluation, input the summary prompt sentence to the generative neural network model, and cause the generative neural network model to generate summary information and explanation information for transmission to the second terminal device.

4. The system according to claim 1, wherein the circuitry is configured to receive the input information as audio data from the first terminal device, convert the audio data into text data by applying speech recognition processing comprising an acoustic model and a language model, and use the text data as the input information for the dialogue history.

5. The system according to claim 4, wherein the circuitry is configured to generate communication data by associating the text data with mode information and identification information, and to process the communication data to extract the input information for the analysis.

6. The system according to claim 1, wherein the generative neural network model comprises a transformer-based architecture including multiple self-attention layers and feed-forward layers, and wherein the circuitry is configured to control at least one of a temperature parameter or a top-k sampling threshold during generation of the analysis result.

7. The system according to claim 1, wherein the structuring process comprises extracting, from the dialogue history, structured fields comprising at least a condition type, a severity indicator, a duration indicator, and an associated attribute, and organizing the structured fields into the structured condition indicator data.

8. The system according to claim 7, wherein the circuitry is configured to preprocess the input information using a language processing program to extract condition-related terms, and to calculate a similarity between the condition-related terms and reference terms stored in the reference category information using a similarity calculation algorithm.

9. The system according to claim 1, wherein the relevance value is calculated by comparing attribute vectors derived from the structured condition indicator data with attribute vectors associated with each candidate category in the reference category information, and computing a distance metric between the attribute vectors.

10. The system according to claim 1, wherein the emotion analysis engine is configured to analyze at least one of text sentiment features, voice prosody features, or facial expression features extracted from the input information to estimate the emotional state of the subject.

11. The system according to claim 10, wherein the circuitry is configured to reflect the emotional state evaluation in the analysis by adjusting at least one of a response style or an information detail level of the additional inquiry sentences based on the estimated emotional state.

12. The system according to claim 1, wherein the circuitry is configured to determine, based on the dialogue history and the analysis result, a processing mode relating to a domain category, and to acquire from the storage device rule information corresponding to the determined processing mode for use in generating the first prompt sentence.

13. The system according to claim 1, wherein the circuitry is configured to execute post-processing on a response sentence generated by the generative neural network model by performing at least one of safety determination and content formatting before transmitting the response sentence to the first terminal device.

14. The system according to claim 1, wherein the circuitry is configured to aggregate condition indicator data obtained from a plurality of users and analyze a temporal transition and a regional distribution of the condition indicator data to detect an occurrence pattern.

15. The system according to claim 1, wherein the circuitry is configured to generate a prompt sentence including an instruction to improve consistency and explainability of a final determination when a specialist operator reviews the candidate category list and the emotional state evaluation result.

16. The system according to claim 1, wherein the circuitry is configured to convert the notification data packet into an output format for presentation using at least one of a character display function or a speech synthesis function.

17. The system according to claim 1, wherein the circuitry is configured to receive the input information from a wearable information display apparatus serving as the first terminal device, and to transmit the additional inquiry sentences for display as visual information superimposed on a display unit of the wearable information display apparatus.

18. A system comprising:
circuitry configured to:
receive, via a communication interface coupled to a packet-switched network, input information from a first terminal device, convert audio data in the input information into text data by speech recognition processing, and store the text data as dialogue history in a storage device;
generate a first prompt sentence including the dialogue history, input the first prompt sentence to a generative neural network model comprising a transformer-based architecture, acquire an analysis result, generate additional inquiry sentences based on the analysis result, transmit the additional inquiry sentences to the first terminal device, and iteratively update the dialogue history with response content until a predetermined information collection condition is satisfied;
generate a structuring prompt sentence, input the structuring prompt sentence to the generative neural network model to acquire structured condition indicator data, compare the structured condition indicator data with reference category information stored in the storage device, and calculate a relevance value for each of a plurality of candidate categories to extract a candidate category list;
evaluate an emotional state of a subject based on the input information using an emotion analysis engine comprising at least one of text sentiment analysis, voice prosody analysis, or facial expression analysis;
generate a summary prompt sentence including the structured condition indicator data, the candidate category list, and the emotional state evaluation result, input the summary prompt sentence to the generative neural network model, and acquire summary information and explanation information; and
transmit, via the communication interface, a notification data packet comprising the structured condition indicator data, the candidate category list, the emotional state evaluation result, and the summary information to a second terminal device.

19. The system according to claim 18, wherein the circuitry is configured to aggregate condition indicator data from a plurality of users, analyze temporal transitions and regional distributions, detect occurrence patterns, and include occurrence pattern information in the notification data packet transmitted to the second terminal device.

20. A method comprising:
receiving, via a communication interface coupled to a packet-switched network, input information expressed in natural language from a first terminal device, and storing the input information as dialogue history in a storage device;
generating a first prompt sentence including the dialogue history, inputting the first prompt sentence to a generative neural network model, and acquiring an analysis result;
generating, based on the analysis result, one or more additional inquiry sentences, transmitting the additional inquiry sentences to the first terminal device, acquiring response content, updating the dialogue history, and repeating the analysis and generation until a predetermined information collection condition is satisfied;
generating a structuring prompt sentence including the dialogue history, inputting the structuring prompt sentence to the generative neural network model, and acquiring structured condition indicator data;
comparing the structured condition indicator data with reference category information stored in the storage device, calculating a relevance value for each of a plurality of candidate categories, and extracting a candidate category list; and
evaluating an emotional state of a subject based on the input information using an emotion analysis engine, and transmitting the structured condition indicator data, the candidate category list, and a result of the emotional state evaluation to a second terminal device via the communication interface.
